(19) United States
(12) Patent Application Publication
(10) Pub. No.: US 2008/0014514 A1
(43) Pub. Date: Jan. 17, 2008

(54) Developer, developing device, image forming apparatus, and image forming method

(75) Inventor: Takanori Kamoto, Yamatokoriyama-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/826,101

(22) Filed: Jul. 12, 2007

(30) Foreign Application Priority Data
Jul. 12, 2006 (JP) 2006-192195
Jul. 9, 2007 (JP) 2007-180109

(51) Int. Cl. G03G 15/01

(52) U.S. Cl. 430/45.56; 430/109.4; 430/111.35; 430/110.4; 430/45.1

(57) ABSTRACT

A developer which contains a toner manufactured in a wet method and a carrier, forms an image which has enhanced image density, image reproducibility, etc., and prevents image defects such as fog from being generated. As the toner manufactured in the wet method, there is used a toner which is obtained in a production method including an admixture preparing step (S1), an aggregate forming step (S2), a particle forming step (S3), and a cleaning step (S4) and which contains pigment and self-dispersible resin containing self-dispersible polyester having an acid number of 1 mgKOH/g to 30 mgKOH/g. As the carrier, there is used a carrier composed of a core material and a coating layer which contains conductive particles formed on a surface of the core material, preferably, a coating layer which is made of a silicone resin composition containing silicone resin and conductive particles.

### CROSS-REFERENCE TO RELATED APPLICATION

This application claims priority to Japanese Patent Applications No. 2006-192195, which was filed on Jul. 12, 2006 and No. 2007-180109, which was filed on Jul. 9, 2007, the contents of which are incorporated herein by reference in its entirety.

### BACKGROUND OF THE INVENTION

1. Field of the Invention

The present invention relates to a developer, a developing device, an image forming apparatus, and an image forming method.

2. Description of the Related Art

Office automation equipments have been remarkably developed in these days and in line with such development, there has been a wide spread of copiers, printers, facsimile machines, and the like machines which form images through the electrophotographic system. In general, an image is formed by way of a charging step, an exposing step, a developing step, a transferring step, a cleaning step, and a fixing step in an image forming apparatus which employs the electrophotographic system. At the charging step, a surface of a photoreceptor serving as an image bearing member is evenly charged in a dark place. At the exposing step, the charged photoreceptor receives signal light derived from a document image, resulting in removal of charges on the exposed part of the photoreceptor whose surface thus carries an electrostatic charge image (an electrostatic latent image). At the developing step, a toner is supplied to the electrostatic charge image on the surface of the photoreceptor, thereby forming a toner image (a visualized image). At the transferring step, a recording medium such as paper or sheet is brought into contact with the toner image on the surface of the photoreceptor, and the corona discharge is then generated toward the recording medium from one side thereof which is reverse to the side in contact with the toner image, to thereby provide the recording medium with charges of which polarity is opposite to that of charges of the toner, thus transferring the toner image onto the recording medium. At the fixing step, the toner image on the recording medium is fixed by heat, pressure, or the like means. At the cleaning step, the toner is collected which has not been transferred onto the recording medium and thus remains on the surface of the photoreceptor. Through the above steps, a desired image is formed by the image forming apparatus employing the electrophotographic system.

A usable developer for developing a toner image in the image forming apparatus employing the electrophotographic system includes a one-component developer containing only a toner and a two-component developer containing toner and carrier. As compared to the one-component developer containing only toner particles, the two-component developer is characterized in forming a high-quality image more easily because functions of stirring, conveying, and charging toner particles can be given to the carrier, and therefore the toner particles need not have such carrier functions, resulting in separation of functions and thus enhancement in controllability. Accordingly, methods have been energetically studied how to manufacture a toner which can be suitably used in combination with a carrier. The heretofore known method of manufacturing a toner includes a dry method and a wet method. One of the dry method called a pulverization method has been widely employed for industrial purposes. In the pulverization method, toner components are melt-kneaded such as synthetic resin (binder resin), pigment (colorant), wax, and a charge control agent, followed by pulverizing and classifying a thus-obtained kneaded material. From another perspective, the reduction in particle diameter of toner has been one of the issues for electrophotographic image forming method to form high-quality images since there has been a demand for high reproducibility in printing a high-resolution and high-quality image displayed on an image display unit such as a liquid crystal panel which has been remarkably developed in these days. When the toner is reduced in particle diameter by the widely-used pulverization method, more energy and time are required for pulverization with more complicated manufacturing process in a lower product-yield, thus causing a problem of sharp rise in production cost. As a result, the wet method has drawn attention because it is relatively easy to manufacture a small toner in the method.

The wet method includes, for example, the following seven method. The first method is called a suspension polymerization method in which a synthetic resin monomer such as a vinyl monomer is polymerized in an aqueous medium containing pigment (refer to Japanese Unexamined Patent Publications JP-A 57-154253 (1982), JP-A 59-62870 (1984), and JP-A 57-181553 (1982), for example). The second method is called an emulsion polymerization method in which water dispersion of synthetic resin particles obtained by polymerization of monomers is mixed with organic solvent dispersion of pigment to thereby form aggregated particles of the synthetic resin particles and the pigment, followed by heating and melting the aggregated particles (refer to Japanese Unexamined Patent Publications JP-A 63-186253 (1988), JP-A 63-282758 (1988), and JP-A 63-282749 (1988), for example). The third method is called a phase inversion emulsification method of obtaining toner particles, the method in which self-water dispersible resin, pigment, and the like ingredient are dissolved or dispersed in an organic solvent, and to the organic solvent is then added a neutralizing agent for neutralizing a dissociable group of resin, and further added water under stirring, to thereby form resin solution droplets encapsulating the pigment and the like ingredient, followed by phase inversion of the resin solution droplets (refer to Japanese Unexamined Patent Publication JP-A 5-66600 (1993), for example). The fourth method is a method of obtaining toner particles, characterized in that an organic solvent solution of resin is added to an aqueous medium containing an inorganic dispersant to form toner particles, followed by removal of the solvent and drying, optionally with adjustment of particle diameter of the inorganic dispersant, modification of type of the resin, and so forth (refer to Japanese Unexamined Patent Publications JP-A 7-152202 (1995), JP-A 7-168395 (1995), JP-A 7-168396 (1995), JP-A 7-219267 (1995), for example). The fifth method is a method in which upon aqueous cleaning of the toner particles obtained in the same manner as the above forth method, the aqueous cleaning is repeated until a difference of electric conductivity reaches 200 μS/cm between water before cleaning and water after cleaning (refer to Japanese Unexamined Patent Publication JP-A 8-179555 (1996), for example). The sixth method is a method in which a surfactant is further added to the aqueous medium together with the organic solvent solution of resin in the above forth method (refer to Japanese Unexamined Patent Publication JP-A 8-179556 (1996), for example). The seventh method is a method in which an inorganic dispersant having an average particle diameter of 0.1 μm to 2 μm is used and a surfactant is further added to the aqueous medium together with the organic solvent solution of resin in the above forth method (refer to Japanese Unexamined Patent Publication JP-A 9-230624 (1997), for example).

The toners obtained in those wet methods described above contain residues such as organic solvents and monomers, which cause variation in charging property of the toner and moreover ooze from a surface of the toner in developing an electrostatic charge image, thereby impairing a member such as a developing roller. A drying step is therefore required for removing the organic solvent, the monomer, and the like ingredient from the toner, but subtle fluctuation of the drying conditions such as pressure, temperature, and time at the drying step will often cause variation in shape, charging property, etc. of the toner. The drying conditions thus need to be optimized and maintained. It is, however, very hard to realize such optimization and maintenance in production of industrial scale. In addition, it will be necessary to provide an equipment to dispose waste liquid attributable to the heavy use of the organic solvent, the monomer, and the like ingredient which heavily burden the natural environment. This increases the production cost of the toner furthermore. The above second method has another drawback such that it is difficult to add the charge control agent, therefore failing to obtain a toner having a desired charging property.

It is further desirable to improve the toner obtained in the heretofore known wet method as described above, in terms of image density and image reproducibility (especially, color reproducibility) of an image formed on a recording medium with the toner, dispersibility of pigment on the recording medium, a transfer rate onto the recording medium, and the like element. It is also desirable to further reduce image defects such as fog.

In view of the foregoing, there has been proposed one method included in the wet method that taking advantage of dispersibility of self-dispersible resin into water, no organic solvent is used and no polymerization reaction is produced. For example, there has been proposed a method of obtaining toner particles, that to emulsion containing self-dispersible resin, i.e., sodium sulfonated polyester particles is added under application of shearing force, pigment-water dispersion containing a pigment-dispersant, i.e., sodium sulfonated polyester, and pigment, and further added is alkali halide, followed by heating the obtained admixture to be thereby aggregated (refer to Japanese Unexamined Patent Publication JP-A 10-39545 (1998), for example). The toner obtained in the method is insufficient in the dispersing performance of pigment into water effected by sodium sulfonated polyester, which generates an aggregate of pigment. The toner has thus not reached a satisfactory level in terms of color reproducibility, etc. In addition, the toner has such a problem that the charging property may vary depending on environmental conditions such as humidity and temperature. This is attributed to influences of acid number of sodium sulfonated polyester.

There has been proposed another method of obtaining toner particles, that water dispersion of self-dispersible resin particles containing a hydrophilic ethylenic unsaturated monomer is mixed with pigment-water dispersion to thus obtain an admixture, and polyvalent metal salt is added to the admixture to generate therein aggregated particles of the self-dispersible resin particles and pigment, followed by heating the admixture up to a temperature equal to or higher than a glass transition temperature of the self-dispersible resin to thereby fuse the aggregated particles (refer to Japanese Unexamined Patent Publication JP-A 2002-131977, for example). In JP-A 2002-131977, examples of the hydrophilic ethylenic unsaturated monomer are stated including styrenesulfonic acid and metal salt thereof, acrylic acid, methacrylic acid, maleic acid, and itaconic acid in paragraph [0029] while specific effects of only sodium styrenesulfonate are described in Example. It would thus appear that the self-dispersible resin disclosed in JP-A 2002-131977 has an acid number which is nearly equal to that of sodium sulfonated polyester disclosed in JP-A 10-39545 (1998). As in the case of the toner of JP-A 10-39545 (1998), the toner of JP-A 2002-131977 also has a problem that the charging property may vary depending on environmental conditions.

There has been proposed still another method of obtaining an aggregate, i.e., toner particles, that water dispersion of vinyl-based resin, water dispersion of self-dispersible polyester, and water dispersion of toner components such as pigment other than binder resin are mixed with each other to thus obtain an admixture to which an aggregating agent, i.e., an ionic surfactant is added, followed by heating (refer to Japanese Unexamined Patent Publication JP-A 2004-354411, for example). According to a technique disclosed in JP-A 2004-354411, only an ionic surfactant is used as the aggregating agent, and no polyvalent metal salt is stated in JP-A 2004-354411. The ionic surfactant does aggregate toner components, but an aggregating force thereof is weak, merely resulting in a soft aggregate formed of toner components which are not tightly bound with each other. This leads to difficulty in controlling a particle diameter of toner particle. Note that paragraphs [0011] and [0012] of JP-A 2004-354411 include the descriptions regarding a carboxylic compound which is to be used as a raw material of polyester. In such descriptions, although trivalent or higher valent carboxylic acids are stated as examples, it is also stated that the use of the trivalent or higher valent carboxylic acids should preferably be avoided as much as possible. Further, in paragraph [0015] of JP-A 2004-354411 is stated that a preferable acid number of the polyester is 10 mgKOH/g to 70 mgKOH/g, but even when the toner manufactured by using such polyester resin is used as a two-component developer, it may not possible to stably apply a constant amount of charges to the toner, depending on a type of the carrier.

Further, there has been proposed a two-component developer which contains a polymerization toner obtained through the suspension polymerization method or the emulsion polymerization method, and a specific carrier (refer to Japanese Unexamined Patent Publication JP-A 2003-167390). A carrier stated in JP-A 2003-167390 contains a core material and a coating layer which is formed on a surface of the core material and made of resin containing a conducting material of 0.5% to 30% by weight, and is characterized in that a ratio of exposed area to surface area of the core material falls in a range of 2% to 20% and that an average area ratio per one exposed part to surface area of the core material is 0.03% or less. In claim 4 of JP-A 2003-167390 is stated silicone-based resin as an example of matrix resin of the coating layer. Moreover, in paragraph [0025] are stated conductive carbon, titanium oxide, tin oxide, etc. as the conducting material. And now, an object of the technique disclosed in JP-A 2003-167390 is to enhance the charging property and in particular, the environmental stability, of the toner by improving the carrier. The charging property of the toner is, however, to be determined intrinsically by a constitution of the toner itself. There is thus a natural limit on the enhancement of the charging property of the toner dependent only on the improvement of the carrier. The publication JP-A 2003-167390 contains no descriptions about the considerable enhancement in the charging property of the toner, which is effected by the use of specific self-dispersible polyester as the binder resin of the toner and by the parallel use of the toner using the self-dispersible polyester as the binder resin and the carrier formed by coating the core material with the conducting material-containing resin.

### SUMMARY OF THE INVENTION

An object of the invention is to provide a developer, comprising a toner manufactured in a wet method, which toner is substantially uniform in particle size and charging property, has stable charging property even upon change of environmental conditions and which is enhanced in pigment dispersibility on a recording medium and a transfer rate onto the recording medium, the developer being capable of forming a high-resolution and high-quality image which is favorable in image density, image reproducibility, etc. with a very small number of image defects such as fog. Another object of the invention is to provide a developing device, an image forming apparatus, and image forming method that use the developer.

The invention provides a developer comprising:

a toner containing pigment and self-dispersible resin which contains self-dispersible polyester having an acid number of 1 mgKOH/g to 30 mgKOH/g; and

a carrier composed of a core material and a coating layer which is formed on a surface of the core material and contains conductive particles.

According to the invention, there is provided a developer comprising: a toner containing pigment and self-dispersible resin which contains self-dispersible polyester having an acid number of 1 mgKOH/g to 30 mgKOH/g; and a carrier composed of a core material and a coating layer which is formed on a surface of the core material and contains conductive particles. Since the toner contains the self-dispersible resin which contains the self-dispersible polyester having an acid number of 1 mgKOH/g to 30 mgKOH/g, it is possible to produce particles which do not contain unnecessary components such as an organic solvent and a monomer and are uniform in particle diameter and shape, by mixing water dispersion of the self-dispersible resin with water dispersion of the other toner component including pigment, for example, thereby causing aggregation. Accordingly, the toner has preferred characteristics such as the charging property less susceptible to the environment, excellent color reproducibility, particularly, excellent secondary color reproducibility, and favorable powder flowability, favorable low-temperature fixing ability, and a high transfer rate onto a recording medium. The toner as just described is contained in the developer of the invention together with the carrier containing the conductive particles in the coating layer. The use of the developer of the invention therefore allows images to be reproduced at high resolution and allows stable formation of high-quality images which are favorable in color reproducibility and high in image density with a small number of image defects such as fog. Since the carrier has the coating layer containing the conductive particles formed on the surface of the core material, even a toner containing no charge control agent can be given charges sufficiently to develop an electrostatic charge image in the case where the developer is used to develop the electrostatic charge image. It is thus not necessary any more to add the charge control agent to the toner, resulting in easier production of the toner.

Further, in the invention, it is preferable that the self-dispersible polyester is formed by polycondensation of an alcohol compound containing polyhydric alcohol and a carboxylic compound containing one or two or more selected from polycarboxylic acids having three or more carboxylic groups in one molecule and acid anhydrides of the polycarboxylic acids.

According to the invention, the self-dispersible polyester contained in the self-dispersible resin in the toner is formed by polycondensation of a carboxylic compound containing polycarboxylic acid having three or more carboxylic groups in one molecule and an alcohol compound containing polyhydric alcohol. This leads to a toner which does not contain unnecessary components such as an organic solvent and a monomer and is uniform in particle diameter and shape, with preferred characteristics such as the charging property less susceptible to the environment, excellent color reproducibility (particularly, excellent secondary color reproducibility), favorable powder flowability, favorable low-temperature fixing ability, and a high transfer rate onto a recording medium. This then results in a developer which allows images to be reproduced at high resolution and allows stable formation of high-quality images which are favorable in color reproducibility and high in image density with a small number of image defects such as fog.

Further, in the invention, it is preferable that the coating layer is formed of a silicone resin composition containing the conductive particles and silicone resin.

According to the invention, the coating layer of the carrier is formed of a silicone resin composition containing the conductive particles and silicone resin. This makes it possible to simultaneously obtain both of the releasing property of the carrier against the toner and the adhesiveness between the coating layer and core material of the carrier, thus leading to a carrier which can stably charge the toner over a long period of time. This thus results in a developer which can more stably form high-quality images.

Further, in the invention, it is preferable that the silicone resin composition contains 30 parts by weight or less of the conductive particles based on 100 parts by weight of the silicone resin.

According to the invention, the silicone resin composition constituting the coating layer of the carrier contains 30 parts by weight or less of the conductive particles based on 100 parts by weight of the silicone resin. The content of the conductive particles over 30 parts by weight based on 100 parts by weight of the silicone resin may cause the carrier to have insufficient charge-imparting ability to the toner. Further, in this case, the mechanical strength of the coating layer and the adhesiveness of the coating layer to the core material may become insufficient to cause the coating layer to be peeled off and thereby expose the core material. By setting the content of the conductive particles at 30 parts by weight or less based on 100 parts by weight of the silicone resin, it is possible to further enhance the charge-imparting ability of the carrier to the toner and moreover enhance the mechanical strength of the coating layer and the adhesiveness of the coating layer to the core material, thus leading to a carrier which can stably charge the toner over a long period of time. Accordingly a developer capable of more stably forming high-quality images can be attained.

Further, in the invention, it is preferable that the coating layer further contains a charge control agent.

According to the invention, the coating layer of the carrier contains a charge control agent together with the conductive particles. In forming images by use of the developer of the invention, charges in the surface of the carrier may be ran out attributable to replacement of the toner oh the surface of the carrier caused by an increase in the number of sheets for image formation. Even in such a case, charges can be supplied to the toner from the charge control agent inside the coating layer by way of the conductive particles when the coating layer of the carrier contains the charge control agent together with the conductive particles. It is therefore possible to stably charge the toner over a long period of time, thus leading to a developer which can more stably form high-quality images.

Further, in the invention, it is preferable that the coating layer is formed of a silicone resin composition containing the conductive particles, the charge control agent, and silicone resin,

wherein the silicone resin composition contains 20 parts by weight or less of the charge control agent based on 100 parts by weight of the silicone resin.

According to the invention, the coating layer is formed of a silicone resin composition containing the conductive particles, the charge control agent, and silicone resin, and the silicone resin composition contains 20 parts by weight or less of the charge control agent based on 100 parts by weight of the silicone resin. The content of the charge control agent over 20 parts by weight based on 100 parts by weight of the silicone resin may lead to insufficient mechanical strength of the coating layer and adhesiveness of the coating layer to the core material to thus cause the coating layer to be peeled off and thereby expose the core material. In the case where the coating layer is peeled off and the core material is thus exposed as just described, the toner spent, which is a phenomenon that a toner is fusion-bonded on a carrier, may be easily caused, or the charges may be excessively supplied from the core material, which causes the charging to be destabilized. Furthermore, the exposure of the core material destabilizes the charging also from the environmental aspect. As an effect that the content of the charge control agent is set at 20 parts by weight or less based on 100 parts by weight of the silicone resin, when the charges in the surface of the carrier are ran out attributable to replacement of the toner on the surface of the carrier caused by an increase in the number of sheets for image formation, the toner can be reliably supplied with charges from the charge control agent inside the coating layer by way of the conductive particles. It is therefore possible to more stably charge the toner, thus leading to a developer which can more stably form high-quality images.

Further, in the invention, it is preferable that a volume average particle diameter of the core material falls in a range of from 25 μm to 150 μm.

According to the invention, a volume average particle diameter of the core material falls in a range of from 25 μm to 150 μm, with the result that the toner is stably conveyed, and high-resolution images can be formed.

Further, in the invention, it is preferable that the core material is made of ferrite particles.

According to the invention, the core material of the carrier is made of ferrite particles, with the result that even when the coating layer is formed on the surface of the core material, it is possible to obtain a carrier which is excellent in the charging property and durability with suitable saturated magnetization. Consequently, the core material can be easily coated with the coating layer.

Further, in the invention, it is preferable that a ratio between a volume average particle diameter of the carrier and a volume average particle diameter of the toner (a volume average particle diameter of the carrier/a volume average particle diameter of the toner) is 5 or more, and a mixing ratio of the toner is 4% to 13%, the mixing ratio which is a ratio of a weight of the toner to a total weight of the developer.

According to the invention, a ratio between a volume average particle diameter of the carrier and a volume average particle diameter of the toner (a volume average particle diameter of the carrier/a volume average particle diameter of the toner) is 5 or more, and a mixing ratio of the toner is 4% to 13%. The mixing ratio is a ratio of a weight of the toner to a total weight of the developer. This contributes to stabilization of the charge-imparting ability to the toner so that the charging property of the toner is further stabilized, and in the case where the developer of the invention is used in a image forming apparatus for forming images at high speed, such as an electrophotographic image forming apparatus, it is possible to stably form high-quality images which are high in the resolution and density, while minimizing a consumption of the toner.

The invention provides a developing device which develops a latent image formed on an image bearing member using the developer mentioned above and thereby forms a toner image.

According to the invention, a latent image formed on an image bearing member is developed using the developer, whereby a toner image is formed. This leads to a developing device which is capable of stably charging the toner and then performing the developing operation.

The invention provides an image forming apparatus comprising:

an image bearing member on which a latent image is formed;

a latent image forming section for forming the latent image on the image bearing member; and

the developing device mentioned above.

According to the invention, a latent image formed on an image bearing member by a latent image forming section is developed by the developing device. In the developing device, the latent image is developed using the developer so that the toner can be stabilized for the developing operation. This therefore results in an image forming apparatus which allows stable formation of high-quality images that reproduce images at high resolution with favorable color reproducibility, high image density, and a small number of image defects such as fog.

Further, in the invention, it is preferable that the image forming apparatus further comprises: an intermediate transferring member on which a plurality of different color toner images formed by developing operations of the developing device are combined with each other to form a multicolor image; and a transfer section for transferring the multicolor image formed on the intermediate transferring member onto a recording medium.

According to the invention, a transfer section transfers to a recording medium a multicolor image which is formed on an intermediate transferring member by combining a plurality of different color toner images formed by developing operations of the developing device. Since the toner can be stably charged over a long period of time, the developer for use in the developing device allows stable and long-lasting formation of high-resolution and high-density multicolor images which are excellent in the image reproducibility including the color reproducibility in the case of transferring the toner image twice such as the case where the transfer section contains the intermediate transferring member and transfers the multicolor image onto the recording medium by way of the intermediate transferring member. As just described, in the case where the transfer section contains the intermediate transferring member, it is possible to effectively exert the effect that high-quality images are stably formed.

The invention provides an image forming method in which the developer mentioned above is used to form a multicolor image composed of a plurality of different color toner images combined with each other.

According to the invention, the developer is used to form a multicolor image composed of a plurality of different color toner images combined with each other. It is thereby possible to stably form high-resolution and high-density multicolor images over a long period of time, which are excellent in the image reproducibility including the color reproducibility.

Further, in the invention, it is preferable that the plurality of the different color toner images are combined to form the multicolor image on an intermediate transferring member, and the formed multicolor image is transferred onto a recording medium.

According to the invention, the multicolor image is formed by combination of the plurality of the different color toner images on an intermediate transferring member, and the multicolor image formed on the intermediate transferring member is transferred onto a recording medium. Since the toner can be stably charged to a constant charge amount, the developer is excellent in the image reproducibility including the color reproducibility and capable of stably forming high-resolution and high-density multicolor images over a long period of time in the case of transferring the toner image twice such as the case where the multicolor image is transferred onto the recording medium by way of the intermediate transferring member.

### BRIEF DESCRIPTION OF THE DRAWINGS

Other and further objects, features, and advantages of the invention will be more explicit from the following detailed description taken with reference to the drawings wherein:

FIG. 1 is a flowchart showing a method of manufacturing a toner for use in the invention;

FIG. 2 is a perspective side view showing a configuration of an image forming apparatus having a developing device according to one embodiment of the invention; and

FIG. 3 is a sectional view showing a configuration of a developing device according to one embodiment of the invention.

### DETAILED DESCRIPTION

Now referring to the drawings, preferred embodiments of the invention are described below.

The invention provides a developer containing a toner, a developing device, an image forming apparatus, and an image forming method.

### [Toner]

The toner used in the invention contains pigment and self-dispersible resin.

As the pigment, it is possible to use inorganic pigment and organic pigment which are customarily used in the relevant field. Examples of the inorganic pigment include black pigment such as various types of carbon black. Examples of the organic pigment include blue pigment, brown pigment, cyan pigment, green pigment, violet pigment, magenta pigment, red pigment, and yellow pigment. To be specific, the pigment includes anthraquinone-based pigment, phthalocyanine blue-based pigment, phthalocyanine green-based pigment, pyrelyne-based pigment, diazo-based pigment, monoazo-based pigment, pyranthrone-based pigment, perylene-based pigment, heterocyclic yellow pigment, quinacridone-based pigment, indigoid-based pigment, and thioindigoid-based pigment. Among the above pigments, preferably used are the anthraquinone-based pigment, the phthalocyanine blue-based pigment, the perylene-based pigment, the heterocyclic yellow pigment, the quinacridone-based pigment, and the thioindigoid-based pigment.

Examples of the anthraquinone-based pigment include pigment red 43, pigment red 194 (perylene red), pigment red 216 (brominated pyranthrone red), and pigment red 226 (pyranthrone red). Examples of the phthalocyanine blue-based pigment include copper phthalocyanine blue and a derivative thereof, i.e., pigment blue 15. Examples of the pyreylene-based pigment include pigment red 123 (Vermillion), pigment red 149 (Scarlet), pigment red 179 (Maroon), pigment red 190 (Red), pigment violet, pigment red 189 (Yellow Shade Red), and pigment red 224.

Examples of the quinacridone-based pigment include pigment orange 48, pigment orange 49, pigment red 122, pigment red 192, pigment red 202, pigment red 206, pigment red 207, pigment red 209, pigment violet 19, and pigment violet 42. Examples of the thioindigoid-based pigment include pigment red 86, pigment red 87, pigment red 88, pigment red 181, pigment red 198, pigment violet 36, and pigment red violet 38.

As the pigment, it is also possible to use a self-dispersible pigment which is obtained by bonding a hydrophilic group to the above-cited pigment. A preferable hydrophilic group is an ionic group among which an anionic group is particularly preferred. Specific examples of the anionic hydrophilic group include a carboxyl group, a phosphate group, a phosphonate group, phosphinate group, and a sulfonate group. These hydrophilic groups may exist in form of salt such as an ammonium slat and a metal salt. The pigments may be used each alone, or two or more of the pigments may be used in combination. In the case of using two or more of the pigments in combination, the pigments of one color may be used together, and the pigments of different colors may also be used together. It is preferred that from the pigments cited above, pigment exhibiting favorable dispersibility into water be appropriately selected for use. A content of the pigment in the toner for use in the invention may be selected from a wide range of content according to toner characteristics as demanded, and preferably is 0.1 part by weight to 20 parts by weight and more preferably is 0.1 part by weight to 15 parts by weight based on 100 parts by weight of the self-dispersible resin. The content of the pigment less than 0.1 part by weight may result in an image which is insufficient in image density while the content of the pigment over 20 parts by weight may decrease pigment dispersibility on a recording medium and thus result in an image which is insufficient in color reproducibility, etc.

As the self-dispersible resin, it is possible to use the self-dispersible polyester in the invention or an admixture of the self-dispersible polyester and self-dispersible resin other than the self-dispersible polyester. The self-dispersible polyester in the invention has an acid number of 1 mgKOH/g to 30 mgKOH/g. In the case of using the self-dispersible polyester whose acid number is less than 1 mgKOH/g, the dispersibility of self-dispersible polyester particles in the later-described water dispersion of self-dispersible polyester is insufficient. When such water dispersion of self-dispersible polyester is used in manufacturing a toner, a toner thus obtained varies in properties thereof including a charging property, for example, depending on environmental conditions such as a temperature and humidity. Moreover, the toner manufactured by using such self-dispersible polyester does not exhibit sufficient charging property. In the case of using the self-dispersible polyester whose acid number exceeds 30 mgKOH/g, the dispersibility of self-dispersible polyester particles in the water dispersion of self-dispersible polyester is favorable, but an obtained toner varies in a charging property thereof depending on the environmental conditions. Accordingly, the acid number of the self-dispersible polyester is set at 1 mgKOH/g or more and 30 mgKOH/g or less. The acid number of the self-dispersible polyester is more preferably 5 mgKOH/g or more and 25 mgKOH/g or less and furthermore preferably 10 mgKOH/g or more and 20 mgKOH/g or less.

The self-dispersible polyester according to the invention includes, for example, a polycondensed material which is obtained by polycondensation of a carboxylic compound and an alcohol compound containing polyhydric alcohol. The carboxylic compound contains one or two or more substances selected from polycarboxylic acids containing three or more carboxylic groups in one molecule, and acid anhydrides of the polycarboxylic acids. The self-dispersible polyester just described will be hereinafter referred to as “self-dispersible polyester (A)”.

The carboxylic compound, i.e., an acid component monomer of the self-dispersible polyester (A) contains polycarboxylic acid in which three or more carboxylic groups exist per one molecule (hereinafter referred to as “trivalent carboxylic acid”), and when needed, the carboxylic component further contains dicarboxylic acid, monocarboxylic acid, and the like ingredient. In particular, the parallel use of the trivalent carboxylic acid and dicarboxylic acid is preferred. As the trivalent carboxylic acid, it is possible to use heretofore known ingredients including, for example, trimellitic acid, trimesic acid, pyromellitic acid, and acid anhydride of these acids just cited. The trivalent carboxylic acids may be used each alone, or two or more of the trivalent carboxylic acids may be used in combination.

As the dicarboxylic acid, it is possible to use heretofore known ingredients including, for example: aromatic dicarboxylic acids such as terephthalic acid, isophthalic acid, o-phthalic acid, 1,5-naphthalene dicarboxylic acid, 2,6-naphthalene dicarboxylic acid, anthracene dipropionic acid, anthracene dicarboxylic acid, diphenic acid, sulfoterephthalic acid, 5-sulfoisophthalic acid, 4-sulfophthalic acid, 4-sulfonaphthalene-2,7-dicarboxylic acid, and 5-(4-sulfophenoxy)isophthalic acid; aromatic oxycarboxylic acids such as p-hydroxybenzoate and p-(hydroxyethoxy)benzoate; aliphatic dicarboxylic acids such as succinic acid, adipic acid, azelaic acid, sebacic acid, and dodecane dicarboxylic acid; aliphatic unsaturated dicarboxylic acids such as fumaric acid, maleic acid, itaconic acid, mesaconic acid, and citraconic acid; aromatic unsaturated dicarboxylic acids such as phenylene diacrylic acid; alicyclic dicarboxylic acids such as hexahydrophthalic acid and tetrahydrophthalic acid; and acid anhydrides of the above cited dicarboxylic acids. Among the above ingredients, preferable are aromatic dicarboxylic acids, and particularly preferable are terephthalic acid, isophthalic acid, and acid anhydrides of these acids. The dicarboxylic acids may be used each alone, or two or more of the dicarboxylic acids may be used in combination.

Examples of the monocarboxylic acid include aromatic monocarboxylic acids such as benzoic acid, chlorobenzoic acid, bromobenzoic acid, p-hydroxybenzoic acid, naphthalene carboxylic acid, anthracene carboxylic acid, 4-methyl benzoic acid, 3-methyl benzoic acid, salicylic acid, thiosalicylic acid, phenyl acetic acid, lower alkyl esters of these acids, sulfobenzoic acid monoammonium salt, sulfobenzoic acid monosodium salt, cyclohexylaminocarbonyl benzoic acid, n-dodecylaminocarbonyl benzoic acid, tert-butyl benzoic acid, tert-butyl naphthalenecarboxylic acid, and acid anhydrides of the above cited ingredients. The monocarboxylic acids may be used each alone, and two or more of the monocarboxylic acids may be used in combination.

In the case where trivalent carboxylic acid and dicarboxylic acid are used in combination as the carboxylic compound, it is favorable that a usage of dicarboxylic acid be set at preferably 70 mol % or more, more preferably 80 mol % or more, and particularly preferably 90 mol % or more, of the total amount of dicarboxylic acid compound. In this case, it is preferred that the dicarboxylic acid be composed of terephthalic acid and isophthalic acid. A use ratio between terephthalic acid and isophthalic acid is not particularly limited. A usage of terephthalic acid may be set at preferably 40 mol % to 95 mol %, more preferably 60 mol % to 95 mol %, and particularly preferably 70 mol % to 90 mol %, of the total amount of dicarboxylic acid while the remaining part is preferably occupied by isophthalic acid. Furthermore, taking a specific example of the use ratio, the use ratio of trivalent carboxylic acid may be set at preferably 0.5 mol % to 8 mol % and more preferably 0.5 mol % to 6 mol % of the total amount of carboxylic compound while the remaining part is preferably occupied by dicarboxylic acid. Moreover, in the case where trivalent carboxylic acid, dicarboxylic acid, and monocarboxylic acid are used in combination as the carboxylic compound, it is favorable that a usage of dicarboxylic acid be set at preferably 70 mol % or more, more preferably 80 mol % or more, and particularly preferably 90 mol % or more, of the total amount of dicarboxylic acid compound. Note that in the case of using terephthalic acid and isophthalic acid for dicarboxylic acid, a use ratio between terephthalic acid and isophthalic acid may be set as described above.

The alcohol compound, i.e., an alcohol component monomer of the self-dispersible polyester (A) contains polyhydric alcohol, monoalcohol, and the like ingredient. As the polyhydric alcohol, it is possible to use heretofore known alcohols including, for example, aliphatic polyhydric alcohol, alicyclic polyhydric alcohol, aromatic polyhydric alcohol, and polyester polyol.

Examples of the aliphatic polyhydric alcohol include aliphatic diols such as ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, and polytetramethylene glycol; triols and tetraols such as trimethylol ethane, trimethylol propane, glycerin, and pentaerythritol.

Examples of the alicyclic polyhydric alcohol include: 1,4-cyclohexanediol, 1,4-cyclohexane dimethanol, spiroglycol, hydrogenated bisphenol A, hydrogenated bisphenol A ethylene oxide adduct and hydrogenated bisphenol A propylene oxide adduct, tricyclodecanediol, and tricyclodecane dimethanol.

Examples of the aromatic polyhydric alcohol include p-xylene glycol, m-xylene glycol, o-xylene glycol, 1,4-phenylene glycol, 1,4-phenylene glycol ethylene oxide adduct, bisphenol A, bisphenol A ethylene oxide adduct, and bisphenol A propylene oxide adduct.

Furthermore, polyester polyol includes, for example, lactone-based polyester polyol which is obtained by ring-opening polycondensation of lactone such as ε-caprolactone.

Among the lacone-based polyester polyol, preferable are aliphatic diol and alicyclic diol. Preferable aliphatic diol includes ethylene glycol, propylene glycol, and 2,3-butanediol while preferable alicyclic diol includes tricyclodecanedimethanol, cyclohexanediol, and cyclohexane dimethanol. Among the above-cited ingredients, aliphatic diol such as ethylene glycol and propylene glycol are particularly preferable. Monoalcohol includes aliphatic alcohol, aromatic alcohol, and alicyclic alcohol. The polyhydric alcohols may be used each alone, and two or more of the polyhydric alcohols may be used in combination. The same is true on the monoalcohol.

A usage of polyhydric alcohol may be set at 50 mol % or more, preferably 70 mol % or more, more preferably 80 mol % or more, and particularly preferably 90 mol % or more, of the total amount of alcohol compound while the remaining part is preferably occupied by monoalcohol. In the case where ethylene glycol and/or propylene glycol are/is used as polyhydric alcohol, it is favorable that a use ratio thereof be set at 50 mol % or more, preferably 60 mol % or more, and more preferably 70 mol % or more of the total amount of alcohol compound.

The self-dispersible polyester (A) can be manufactured, for example, in a manner that the carboxylic compound other than trivalent carboxylic acid, and the alcohol compound are polycondensated with each other to thereby obtain a polycondensed material which is then reacted with trivalent carboxylic acid. The polycondensation reaction can be carried out according to a heretofore known method. For example, an admixture of the carboxylic compound other than trivalent carboxylic acid, and the alcohol compound may be heated under the presence of a transesterification catalyst or an esterification catalyst. A use ratio between the carboxylic compound other than trivalent carboxylic acid, and the alcohol compound is not particularly limited and may be appropriately selected according to properties of intended polyester.

As the transesterification catalyst, it is possible to use heretofore known catalysts including, for example: metal acetate such as zinc acetate, lead acetate, and magnesium acetate; metal oxide such as zinc oxide, and antimony oxide; and metal alkoxide such as tetrabutoxy titanate. As the esterification catalyst, it is also possible to use heretofore known catalysts including, for example: an organic metal compound such as dibutyltin dilaurate, and dibutyltin oxide; and metal alkoxide such as tetrabutoxy titanate.

The heating operation includes two stages such as about one to six hour heating at a temperature around 150° C. to 220° C., followed by about one to three hour heating at a temperature around 230° C. to 260° C., preferably under reduced pressure. The polycondensed material thus obtained can be directly brought to the reaction for introducing the carboxylic group. Next, the reaction between the polycondensed material obtained as above and trivalent carboxylic acid is effected by heating the admixture of the polycondensed material and trivalent carboxylic acid, preferably, in an atmosphere of inert gas such as nitrogen gas. The heating operation is carried out at a temperature around 180° C. to 220° C. and completed in around 0.5 to 3 hours. The self-dispersible polyester (A) is thereby obtained in which a carboxylic group is introduced into a main chain of the polycondensed material. In the reaction, the trivalent carboxylic acid may be used in form of salt. In such a case, it is preferred that a counter cation of trivalent carboxylic acid salt be a monovalent cation.

As the need arises, the self-dispersible polyester (A) may be neutralized with ammonia, alkali metal hydroxide, and the like ingredient, thereby having the carboxylic group in form of ammonium salt, alkali metal salt, etc. Further, the self-dispersible polyester (A) thus obtained may be hydrophobized by acid cleaning.

The self-dispersible polyester (A) is synthesized mainly by polycondensation of divalent or higher valent carboxylic acid and divalent or higher valent alcohol, and the self-dispersible polyester (A) is therefore in form of resin which exhibits a broad molecular weight distribution and which is hard to gelate. A content of insoluble chloroform in the self-dispersible polyester (A) is 0.5% by weight or less and preferably 0.25% by weight or less while an acid number of the self-dispersible polyester (A) is 40 mgKOH/g or less and preferably 30 mgKOH/g or less. Among the self-dispersible polyester (A), self-dispersible polyester having an acid number of 1 mgKOH/g or more and 30 mgKOH/g or less is used as the self-dispersible polyester in the invention.

Further, it is preferable to use the self-dispersible polyester (A) whose glass transition temperature is preferably 40° C. to 80° C., more preferably 45° C. to 80° C., and particularly preferably 50° C. to 75° C., or whose softening temperature is preferably 80° C. to 150° C., more preferably 85° C. to 150° C., and particularly preferably 85° C. to 145° C. The self-dispersible polyester (A) whose glass transition temperature is lower than 40° C. or whose softening temperature is lower than 80° C. will easily cause a resultant toner to suffer from blocking, which may decrease the preservation stability of the toner. On the other hand, the self-dispersible polyester (A) whose glass transition temperature exceeds 80° C. or whose softening temperature exceeds 150° C. will deteriorate the fixing property of a resultant toner and give rise to a need for heating of a fixing roller which is used to fix onto a recording medium a toner image transferred thereto, until a temperature of the fixing roller becomes high, wherefore usable materials are limited for the fixing roller and the recording medium onto which the toner image is to be transferred.

Moreover, taking account of application of the resultant toner, i.e., the use as a color toner; a purpose of enhancing the fixing property onto an OHP sheet, etc.; and a purpose of preventing the toner from being defectively fixed onto a recording medium due to a shift of an offset region to a higher temperature, a molecular weight is preferably 2,000 to 200,000 and more preferably 2,000 to 50,000 while a number average molecular weight is preferably 2,000 to 30,000, more preferably 3,000 to 25,000, and particularly preferably 3,000 to 20,000. The molecular weight over 200,000 may lead to deterioration of the self-dispersibility while the molecular weight less than 2,000 may lead to a decrease in the durability level of the toner.

A content of the self-dispersible polyester (A) in the self-dispersible resin is preferably 50% by weight or more, more preferably 80% by weight or more, and particularly preferably 90% by weight, of the total amount of self-dispersible resin. The content of the self-dispersible polyester (A) less than 50% by weight may form a toner which is not sufficiently satisfactory in terms of the color reproducibility, the adhesiveness to a recording medium, and the like factor. The self-dispersible resin may be, as a matter of course, formed wholly of the self-dispersible polyester (A).

The self-dispersible polyester according to the invention is not limited to the self-dispersible polyester (A), and any self-dispersible resin may be used as long as an acid number thereof falls in a range of from 1 mgKOH/g to 30 mgKOH/g. The self-dispersible polyester other than the self-dispersible polyester (A) is, for example, obtained by bonding the hydrophilic group such as a sulfonate group and phosphate group to at least either one of the main chain and side chain of polyester, or obtained by copolymerization of acrylic acid to polyester. An amount of the sulfonate group should be taken into consideration when introduced into at least either one of the main chain and side chain of polyester since the sulfonate group may adversely affect the charging property of the toner.

The selection of self-dispersible resin other than the self-dispersible polyester is not particularly limited as long as the resin can be dispersed in water, including self-dispersible vinyl-based copolymer resin, self-dispersible polyurethane, and self-dispersible epoxy resin. The self-dispersible resins may be used each alone, and two or more of the self-dispersible resins may be used in combination. In each of these self-dispersible resins, a hydrophilic group is bonded to at least either one of the main chain and the side chain. A hydrophilic group bonded to the main chain or side chain of the self-dispersible resin cited above is preferably an ionic group among which an anionic group is particularly preferred. Specific examples of the hydrophilic group include a carboxyl group, a phosphate group, a phosphonate group, and phosphinate group. These groups may exist in form of salt such as an ammonium slat and a metal salt. Note that an amount of a sulfonate group should be taken into consideration when introduced into at least either one of the main chain and side chain of the self-dispersible resin since the sulfonate group may adversely affect the charging property of the toner as described above. In the case of using the self-dispersible resin other than the self-dispersible polyester, an amount of the resin may be set such that a total amount of the resin and the self-dispersible polyester is 100, that is to say, a predetermined amount of the self-dispersible polyester and a remaining amount of the self-dispersible resin other than the self-dispersible polyester constitute a whole self-dispersible resin part.

The toner for use in the invention may contain wax together with the pigment and the self-dispersible resin. As the wax, it is possible to use heretofore known wax including, for example, natural wax such as carnauba wax and rice wax; synthetic wax such as polypropylene wax, polyethylene wax, and Fischer-Tropsch wax; coal wax such as montan wax; alcohol wax; and ester wax. The waxes may be used each alone, or two or more of the waxes may be used in combination. Although the wax is used in form of particles, an encapsulated form may also be applicable in which surfaces of the wax particles are coated with synthetic resin. The encapsulated wax thus has a surface coated with the synthetic resin, and when added to a toner, the encapsulated wax is not exposed on a surface of the toner, therefore being preferable in terms of enhancement in spent of the toner to the carrier. A usage of the wax is preferably 0.5 part by weight to 20 parts by weight and more preferably 1 part by weight to 10 parts by weight based on 100 parts by weight of the self-dispersible resin.

In the invention, an external additive may be added to the toner particles which have been shaped into particles, thereby modifying surfaces of the toner particles. As the external additive, it is possible to use an additive which is customarily used in the relevant field including, for example, water-dispersible inorganic particles such as silica and titanium oxide, and silicone resin. A particle diameter of the water-dispersible inorganic particle is not particularly limited, and preferably 1 μm or less and more preferably 0.01 μm to 0.8 μm. The external additives may be used each alone, and two or more of the external additives may be used in combination. Further, it is also possible to use two or more of the water-dispersible inorganic particles in combination. A usage of the external additive is not particularly limited and preferably 1 part by weight to 10 parts by weight based on 100 parts by weight of the toner particles. Furthermore, the inorganic particles just described may have been hydrophobized with a silicone coupling agent before use.

Further, in the invention, a commonly-used toner additive such as a charge control agent or a release agent may be added as an external additive to the toner particles which have been shaped into particles. Note that such a charge control agent or release agent is also usable as an internal additive which is originally contained in the toner particles.

[Method of Manufacturing Toner]

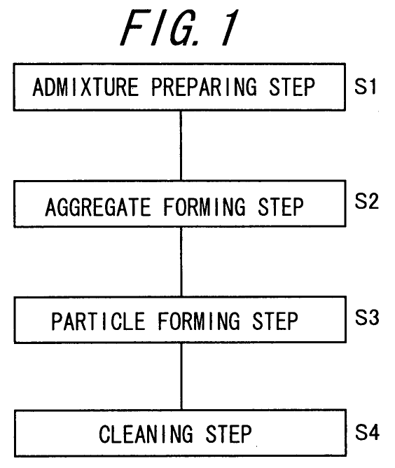

The toner for use in the invention can be manufactured by a manufacturing method including an admixture preparing step and an aggregate forming step. FIG. 1 is a flowchart showing one embodiment of a method of manufacturing a toner. The method of manufacturing a toner shown in FIG. 1 includes an admixture preparing step S1, an aggregate forming step S2, a particle forming step S3, and a cleaning step S4. Note that pigment, self-dispersible resin, wax, and an external additive to be used in the manufacturing method of the invention are respectively the same as those indicated as the components of the toner for use in the invention.

At the admixture preparing step S1, pigment-water dispersion and water dispersion of self-dispersible resin are mixed with each other to thereby prepare a toner component admixture. The pigment-water dispersion can be prepared by mixing pigment and water. An addition of an appropriate amount of a dispersant in mixing the pigment and the water will enhance dispersibility of the pigment into the water and reduce a particle diameter of the pigment being dispersed. Further, the dispersant can be removed at the later-described cleaning step and therefore poses no risk of changing toner characteristics. As the dispersant, it is possible to use an ingredient which is customarily used in the relevant field including, for example, a surfactant. Among the surfactant, preferable are an anionic surfactant, a nonionic surfactant, etc. A content of the pigment in the pigment-water dispersion is not particularly limited and in consideration of working efficiency, preferably around 0.1% by weight to 20% by weight of the total amount of pigment-water dispersion.

The pigment and water are mixed by a mixing machine, for example. As the mixing machine, it is possible to use a heretofore known emulsifying machine, dispersing machine, etc. and preferably used is the following apparatus. The apparatus is capable of receiving the toner components such as the pigment, self-dispersible resin, and wax, and the aqueous medium in a batch process or continuous process. In the apparatus, a heating section is provided to heat the toner components and the aqueous medium which are being mixed with each other, to thereby obtain a toner composed of binder resin particles containing the pigment. The apparatus is then capable of discharging the toner in the batch or continuous process. Further, the emulsifying machine or dispersing machine in which shearing force can be given to an admixture of the toner components and the aqueous medium, are preferable in that an obtained aggregate can be more easily formed into particles which are uniform in size and shape. Furthermore, the mixing machine preferably has at least either of a stirring section and a rotating section so that the toner components and the aqueous medium being mixed with each other can be stirred or rotated.

Furthermore, in the mixing machine, a mixing container for mixing the toner components and the aqueous medium preferably has a heat-retaining section. Specific examples of the emulsifying machine and the dispersing machine include: a batch-type emulsifying machine such as Ultra Turrax (trade name) manufactured by IKA Japan K.K., Polytron Homogenizer (trade name) manufactured by Kinematica Co., T.K. Autohomomixer (trade name) manufactured by Tokushu Kika Kogyo K.K., and Max Blend (trade name) manufactured by Sumitomo Heavy Industries, Ltd.; a continuous-type emulsifying machine such as Ebara Milder (trade name) manufactured by Ebara Corporation, T.K. Pipeline Homomixer (trade name) manufactured by Tokushu Kika Kogyo K.K., T.K. Homomic Line Flow (trade name) manufactured by Tokushu Kika Kogyo K.K., Filmix (trade name) manufactured by Tokushu Kika Kogyo K.K., Colloid Mill (trade name) manufactured by Shinko Pantec Co., Ltd., Slusher (trade name) manufactured by Mitsui Miike Kakoki Co., Ltd., Trigonal Wet Grinder (trade name) manufactured by Mitsui Miike Kakoki Co., Ltd., Cavitron (trade name) manufactured by Eurotec, Ltd., and Fine Flow Mill (trade name) manufactured by Taiheiyo Kiko Co., Ltd.; Clearmix (trade name) manufactured by M Technique Co., Ltd.; and Filmics (trade name) manufactured by Tokushu Kika Kogyo K.K. The mixing machines cited above may be used not only for preparation of the pigment-water dispersion, but also for preparation of the water dispersion of self-dispersible resin, preparation of wax-water dispersion, mixing of the pigment-water dispersion and the water dispersion of self-dispersible resin, preparation of aggregated particles of toner components through addition of polyvalent metal salt, heating of the aggregate particles, cleaning the toner particles obtained by heating the aggregated particles, and the like operation.

The water dispersion of self-dispersible resin can be prepared, as in the case of the pigment-water dispersion, by mixing the self-dispersible resin and water with each other in the mixing machine such as the emulsifying machine or the dispersing machine. Furthermore, in preparing the water dispersion of self-dispersible resin, it is possible to adjust average particle diameter and particle size distribution of resin particles of the self-dispersible resin being dispersed in the water. Example of usable preparation method include: a method that the self-dispersible resin and a water-soluble organic solvent have been respectively heated to 50° C. to 200° C. in advance and are mixed with each other to form an admixture to which water is then added; a method that water is added to an admixture of the self-dispersible resin and a water-soluble organic solvent (which will act as a counter cation, for example), and the admixture is then heated to 40° C. to 120° C.; and a method that the self-dispersible resin is added to an admixture of water and a water-soluble organic solvent, and the admixture is then heated to 40° C. to 100° C. and stirred. In the methods just cited, a neutralizing operation can be carried out after the reaction by adding an alkaline chemical of which equivalent weight depends on an acid number of the self-dispersible resin. Examples of the water-soluble organic solvent include: lower alcohols such as ethanol, butanol, and isopropanol; cellosolves such as ethyl cellosolve and butyl cellosolve; ethers such as dioxane and tetrahydrofuran; ketones such as acetone and methyl ethyl ketone; and a mixed solvent of two or more of the ingredients just cited.

In the methods, the average particle diameter and particle size distribution of the self-dispersible resin particles can be adjusted by appropriately selecting the usages of the self-dispersible resin, water-soluble organic solvent, and water, the heating temperature, the type of the water-soluble organic solvent, the length of time for mixing, and the like factor. Note that in the methods, the water-soluble organic solvent is removed through heating after the self-dispersible resin particles have been formed, thus resulting in the water dispersion of self-dispersible resin in which are dispersed the self-dispersible resin particles having desired average particle diameter and particle size distribution. The average particle diameter of the self-dispersible resin particles is not particularly limited, and preferably 0.2 μm or less, more preferably 0.01 μm to 0.18 μm, and particularly preferably 0.01 μm to 0.15 μm. Note that the average particle diameter of the self-dispersible resin particles over 0.2 μm may result in too large aggregated particles obtained at the later-described aggregate forming step S2, which causes the difficulty in controlling the particle diameter of the toner. A content of the self-dispersible resin (resin particles) in the water dispersion of self-dispersible resin is not particularly limited, and preferably 80% by weight to 99% by weight of the total amount of the water dispersion of self-dispersible resin in consideration of easiness in forming aggregated particles at the later-described aggregate forming step S2, working efficiency, and the like factor.

At the present step, the wax-water dispersion can be mixed with the pigment-water dispersion and the water dispersion of self-dispersive resin. The wax-water dispersion can be prepared by a method of emulsifying wax with a surfactant, or a method of emulsifying into water, wax particles or encapsulated wax in which surfaces of wax particles are coated with synthetic resin. The pigment-water dispersion and the water dispersion of self-dispersible resin are mixed with each other, for example, through about one to five hour stirring at a room temperature by use of the mixing machine as cited above. The toner component admixture is thus prepared.

At the aggregate forming step S2, polyvalent metal salt is added to the toner component admixture under stirring, thereby forming an aggregate (aggregated particles) containing the toner components. The polyvalent metal salt used as an aggregating agent at the present step is divalent or higher valent metal salt. The selection of the divalent or higher valent metal is not particularly limited, and usable are alkali earth metals such as magnesium, calcium, and barium; and thirteen group in the periodic series such as aluminum, among which magnesium and aluminum are preferred. Specific examples of the divalent or higher valent metal include magnesium sulfate, aluminum sulfate, barium chloride, magnesium chloride, calcium chloride, aluminum chloride, aluminum hydroxide, and magnesium hydroxide. In the case where the self-dispersible pigment is used as pigment, both of the pigment and the self-dispersible resin have hydrophilic groups or hydrophilic groups in form of salt and therefore, among the above-cited metals, it is preferable to select divalent or higher valent metal salt which ionically bind the pigment to the self-dispersible resin. Further, magnesium chloride and aluminum sulfate are preferable because of relatively high solubility thereof into water, which is advantageous for the removal conducted through cleaning with pure water at the later-described cleaning step S4. Among the above-mentioned metal salts, magnesium salt is the most appropriate in terms of control over the particle diameter of aggregated particles since magnesium salt has divalent ions and is therefore lower in aggregating speed than that of aluminum salt having trivalent ions. The polyvalent metal salts may be used each alone, and two or more of the polyvalent metal salts may be used in combination.

Furthermore, in the invention, a commonly-used organic compound-based aggregating agent such as dimethylaminoethyl(2,2-dimethylol)propionate may also be used together with or instead of the polyvalent metal salt. A usage of the aggregating agent is preferably 0.5 part by weight to 20 parts by weight, more preferably 0.5 part by weight to 18 parts by weight, and particularly preferably 1.0 part by weight to 18 parts by weight based on 100 parts by weight of the toner components (the total amount of the pigment and the self-dispersible resin, or the total amount of the pigment, the self-dispersible resin, and the wax). The aggregating agent less than 0.5 part by weight may lead to insufficient aggregating effects while the aggregating agent over 20 parts by weight may cause the aggregated particles to be too large.

Further, at the present step, the water dispersion of self-dispersible resin may also be added to the toner component admixture together with the polyvalent metal salt, followed by mixing of the admixture. In this case, it is preferred that the water dispersion of self-dispersible resin for use at the above-described admixture preparing step S1 be reduced in advance by an amount of resin contained in the water dispersion of self-dispersible resin to be used at the present step. Further, at the present step, in order to prevent the produced aggregated particles from being reaggregated, a surfactant may be added to a mixed system of the toner component admixture and the polyvalent metal salt, or alternatively, a commonly-used alkaline chemical such as sodium hydroxide or potassium hydroxide may be added to the mixed system of the toner component admixture and the polyvalent metal salt to thereby adjust pH of the mixed system to be eight or more. The toner component admixture and the polyvalent metal salt are mixed at a temperature in a range of from about a room temperature to a glass transition temperature (Tg) of the self-dispersible resin, preferably at a room temperature, by use of the commonly-used mixing machine as cited above. In this case, it is preferable to use a mixing machine which is capable of applying mechanical shearing force. This makes it possible to form the aggregated particles which are further uniform in particle size and shape.

At the particle forming step S3, an aqueous medium containing the aggregated particles obtained at the aggregate forming step S2 is heated to thereby form toner particles. A heating temperature is set at a temperature equal to or higher than the glass transition temperature of the self-dispersible resin of which amount contained in the aggregated particles is the largest. As a result, the toner particles are obtained of which particle diameter falls in a range of from 1 μm to 20 μm and which are uniform in shape and particle diameter.

For the purpose of forming the toner particles exhibiting further uniform charging property, shape, etc., the water dispersion of self-dispersible resin may be added at the present step to the aqueous medium containing the aggregated particles before the aqueous medium is heated. The aqueous medium containing the aggregated particles obtained at the aggregate forming step S2 contains aggregated particles to whose surfaces the pigment is attached, aggregated particles on whose surface layer the pigment exists, aggregated particles which contain a larger amount of the pigment inside than that in a surface layer, and the like aggregated particles. The formation of toner particles through heating of the aggregated particles in such a state may result in a toner that contains toner particles which are varied in charging property. The difference in charging property may be larger between the case where the pigment is a conductive substance such as carbon black and the case where the pigment is colored pigment (of cyan, magenta, yellow, etc.). This gives rise to a need of individual study on design of the developer according to the pigment for use. Considering that the charging property of the toner is determined mainly according to the property of surfaces of the toner particles, a toner is designed so that the pigment is not exposed on the surfaces of the toner particles. By so doing, it is possible to obtain a toner which is substantially equal in the charging property, regardless of type of the pigment. In view of the foregoing, the water dispersion of self-dispersible resin is added so that a self-dispersible resin-coating layer is further formed on the surfaces of the aggregated particles to which the pigment is attached or whose surface layer contains the pigment. This allows the toner particles to be further uniform in the charging property, shape, etc. Furthermore, a resin layer formed on the surface of the toner particle will provide the expectation of additional effect that the spent of the carrier caused by the wax can be prevented from appearing. When adding the water dispersion of self-dispersible resin, a surfactant may be added, or alternatively a commonly-used alkaline chemical such as sodium hydroxide may be added so that pH of the water dispersion of aggregated particles is adjusted to be eight or more, in order to prevent the aggregated particles from being mutually reaggregated. Further, in the case of adding the water dispersion of self-dispersible resin at the present step, it is preferred that the water dispersion of self-dispersible resin for use at the admixture preparing step S1 be reduced in advance by an amount of resin contained in the water dispersion of self-dispersible resin to be used at the present step.

At the cleaning step S4, the toner particles (the aggregated particles) obtained at the particle forming step S3 are cleaned. The cleaning of the toner particles is conducted mainly for the purpose of the removal of unnecessary components other than the toner components, including such impurities as adversely affecting the charging property of the toner and an unnecessary aggregating agent (polyvalent metal salt) which has not been involved in the aggregation and thus remained. This makes it possible to form a toner which does not contain an unnecessary component.

In cleaning the toner particles, there is used pure water of which electric conductivity is 20 μS/cm or less. The pure water just described can be obtained by a heretofore known method including, for example, an activated carbon method, an ion exchange method, a distillation method, and a reverse osmosis method, and may be obtained by a combination of a plurality of these methods. The cleaning of the toner particles is carried out in a manner that only the toner particles obtained at the particle forming step S3 are firstly isolated from the aqueous medium containing the toner particles by use of a commonly-used separating section such as a filtration device or a centrifuge, and thus-obtained toner particles are cleaned with the pure water of which electric conductivity is 20 μS/cm or less. It is preferred that the cleaning by use of the pure water exhibiting the electric conductivity of 20 μS/cm or less be repeated until the electric conductivity of the water used for the cleaning reaches 50 μS/cm or less. A temperature of the pure water is preferably equal to or less than the lowest glass transition temperature of the self-dispersible binder resin in order to prevent the toner particles from being mutually reaggregated. The cleaning as just described may be carried out in either batch process or continuous process. Furthermore, in mid-course of the cleaning with the pure water, one or two or more cleanings of another type may be conducted which uses water exhibiting pH of six or less. This allows sufficient removal of impurities.

After completion of the cleaning, the cleaned toner particles may be dried by a drying machine such as a vacuum drier according to need. To the toner particles obtained through the drying operation, an appropriate amount of an external additive may be added which includes, for example, a surface modifier such as water-dispersible inorganic particles and silicone resin, a charge control agent, and a release agent. A volume average particle diameter of a thus-obtained toner for use in the invention is preferably 10 μm or less, more preferably 2 μm to 9 μm, and particularly preferably 3 μm to 8 μm in an average particle diameter. The volume average particle diameter over 10 μm will result in a broad particle size distribution and thus largely-varied charging property in the method of manufacturing a toner, which may cause image defects.

[Developer]

The developer of the invention is a two-component developer which contains the toner manufactured in a method disclosed in the invention, and a carrier. The toner is the same toner as described above. The carrier contains a core material and a coating layer formed on a surface of the core material. As the core material, it is possible to use a magnetic substance which is customarily used in the relevant field including, for example, magnetic metals such as iron, copper, nickel, and cobalt, and magnetic metal oxides such as ferrite and magnetite. The carrier of which core material is made of a magnetic material as cited above, is suited for a developer to be used in the magnetic brush development method.

A volume average particle diameter of the core material of the carrier is preferably 25 μm to 150 μm and more preferably 25 μm to 90 μm. In the present specification, the volume average particle diameter of the carrier is a value which is measured by a particle sizing device: Microtrac MT3000 (trade name) manufactured by Nikkiso Co., Ltd. When the core material of the carrier has the volume average particle diameter of 25 μm to 150 μm, the toner is stably conveyed, and high-resolution images can be formed. The volume average particle diameter of the core material less than 25 μm will easily cause the carrier to be detached from the developer-conveying member, thus easily leading to carrier attachment which is a phenomenon that the carrier is attached to the image bearing member. In the case where the volume average particle diameter of the core material exceeds 150 μm, the effect of enhancement in image quality attributable to the toner is not seen even using a diameter-reduced toner since the magnetic brush, which is formed by magnetically attracting the carriers to a magnet roller mentioned later, becomes too rough.

The core material of the carrier is preferably made of ferrite particles. By using the ferrite particles to form the core material of the carrier, it is possible to obtain a carrier which is excellent in the charging property and durability with suitable saturated magnetization, even when the coating layer is formed on the surface of the core material. Consequently, the core material can be easily coated with the coating layer.

The coating layer contains the conductive particles.

Since the toner of the invention contains the self-dispersible resin which contains the self-dispersible polyester having an acid number of 1 mgKOH/g to 30 mgKOH/g as described above, it is possible to produce particles which do not contain excess components such as an organic solvent and a monomer and are uniform in particle diameter and shape, by mixing water dispersion of the self-dispersible resin with water dispersion of the other toner component including pigment, for example, thereby causing aggregation. Accordingly, the toner has preferred characteristics such as the charging property less susceptible to the environment, excellent color reproducibility, particularly, excellent secondary color reproducibility, and favorable powder flowability, favorable low-temperature fixing ability, and a high transfer rate onto a recording medium.

The toner as just described is contained in the developer of the invention together with the carrier containing the conductive particles in the coating layer. The use of the developer of the invention therefore allows stable formation of high-quality images which reproduce images at high resolution with favorable color reproducibility, high image density, and a small number of image defects such as fog. Since the carrier has the coating layer containing the conductive fine particles formed on the surface of the core material, even a toner containing no charge control agent can be given charges sufficiently to develop an electrostatic charge image in the case where the developer is used to develop the electrostatic charge image. It is thus not necessary any more to add the charge control agent to the toner, resulting in easier production of the toner.

In the embodiment, the coating layer is made of a silicone resin composition which contains silicone resin and conductive particles. When the coating layer of the carrier is formed of the silicone resin composition containing the conductive particles and silicone resin as described above, it is possible to simultaneously obtain both of the releasing property of the carrier against the toner and the adhesiveness between the coating layer and core material of the carrier, thus leading to a carrier which can stably charge the toner over a long period of time. This thus results in a developer which can more stably form high-quality images.

The selection of the silicone resin is not particularly limited, and it is possible to use silicone resin which is customarily used in the relevant field. Preferably used is cross-linked silicone resin. The cross-linked silicone resin indicates heretofore known silicone resin in which hydroxyl groups bonded to a Si atom or a hydroxyl group and a —OX group bonded to a Si atom are cross-linked with each other and cured by a thermal dehydration reaction, a cold setting reaction, and the like reaction as represented below.

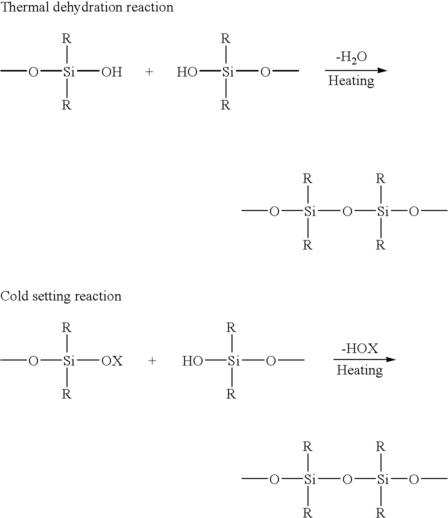

wherein a plurality of “R”s represent monovalent organic groups which may be the same or different, and —OX group represents an acetoxy group, an aminoxy group, alkoxy group, an oxime group, etc.

As the cross-linked silicone resin, both of thermosetting silicone resin and cold setting silicone resin are usable. In order to cross-link the thermosetting silicone resin, it is necessary to heat the resin up to a temperature around 200° C. to 250° C. In order to cure the cold setting silicone resin, although it is not necessary to heat the resin, the resin is preferably heated up to a temperature around 150° C. to 280° C. for the purpose of shortening a length of time required for curing. Among the cross-linked silicone resin, preferable is the silicone resin of which monovalent organic group represented by R is a methyl group. Since the cross-linked silicone resin containing a methyl group represented by R has a dense cross-linked structure, the use of the cross-linked silicone resin in forming the resin-coating layer on the carrier core material will result in a carrier which is favorable in water-shedding property, moisture resistance, and the like property. However, too dense a cross-linked structure tends to decrease the strength of the resin-coating layer. It is therefore important to select a molecular weight of the cross-linked silicone resin. Further, a weight ratio (Si/C) between silicon and carbon in the cross-linked silicone resin is preferably 0.3 to 2.2. The weight ratio (Si/C) less than 0.3 may decrease hardness of the resin-coating layer and thus shorten a length of carrier life. The weight ratio (Si/C) over 2.2 may make the charge-imparting property of the carrier to the toner more susceptible to a temperature change and thus decrease the strength of the resin-coating layer.

In the invention, it is possible to use a commercially-available cross-linked silicone resin including, for example: SR2400, SR2410, SR2411, SR2510, SR2405, 840RESIN, and 804RESIN, all of which are trade names and manufactured by Dow Corning Toray Co., Ltd.; and KR271, KR272, KR274, KR216, KR280, KR282, KR261, KR260, KR255, KR266, KR251, KR155, KR152, KR214, KR220, X-4040-171, KR201, KR5202, KR3093, all of which are trade names and manufactured by Shin-Etsu Chemical Co., Ltd. The cross-linked silicon resins may be used each alone, and two or more of the cross-linked silicon resins may be used in combination.

As the conductive particles, inorganic particles having conductivity can be preferably used, among which inorganic oxide-based conductive particles are preferred. Specific examples of the conductive particles include conductive carbon black, conductive titanium oxide, antimony-doped conductive titanium oxide, conductive tin oxide, and tin oxide/indium oxide (ITO). Among the substances just cited, the conductive carbon black is preferred to express, with a small amount thereof, sufficient conductivity. Further, in the case of the use for a color toner, it is preferable to use the antimony-doped conductive titanium oxide, tin oxide/indium oxide (ITO), and the like substance, if there is a concern about detachment of the conductive carbon black from the coating layer. Each type of the conductive particles may be used alone, and two or more types thereof may be used in combination. A volume average particle diameter of the conductive particles is not particularly limited, and preferably 0.02 μm to 2 μm and more preferably 0.02 μm to 1 μm. Note that the volume average particle diameter is a value measured by a Coulter counter: Coulter Counter Multisizer II (trade name) manufactured by Beckman Coulter, Inc.

A content of the conductive particles in the silicone resin composition is not particularly limited, and preferably 30 parts by weight or less and more preferably 1 part by weight or more and 30 parts by weight or less based on 100 parts by weight of the silicone resin. The content of the conductive particles over 30 parts by weight based on 100 parts by weight of the silicone resin will easily cause the conductive particles to fall off the coating layer, thus leading to concern that a color image is affected. Further, in this case, the mechanical strength of the coating layer and the adhesiveness of the coating layer to the core material may become insufficient to cause the coating layer to be peeled off and thereby expose the core material. When the coating layer is peeled off and the core material is exposed as just described, the charging property will be different from that given by the original carrier, with the result that the toner may fail to be stably charged. By setting the content of the conductive particles at 30 parts by weight or less based on 100 parts by weight of the silicone resin, the conductive particles are prevented from falling off the coating layer and it is thus possible to reduce the influence on the color image. Further, in this case, the mechanical strength of the coating layer and the adhesiveness of the coating layer to the core material can be enhanced, thus attaining a carrier which can stably charge the toner over a long period of time. This thus results in a developer which can more stably form high-quality images.

When the content of the conductive particles is less than 1 part by weight based on 100 parts by weight of the silicone resin, the effect obtained by addition of the conductive particles may not appear, possibly failing to impart sufficient charges to the toner. By setting the content of the conductive particles at 1 part by weight or more based on 100 parts by weight of the silicone resin, the effect obtained by addition of the conductive particles more reliably appears and it is thus possible to impart sufficient charges to the toner.

In the embodiment, the coating layer further contains a charge control agent. To be more specific, the coating layer is formed of a silicone resin composition containing silicone resin, conductive particles, and the charge control agent. The coating layer does not have to contain the charge control agent, but it is preferred that the coating layer contain the charge control agent just like the present embodiment. In forming images by use of the developer of the invention, charges in the surface of the carrier may be ran out attributable to replacement of the toner on the surface of the carrier caused by an increase in the number of sheets for image formation. Even in such a case, when the coating layer contains the charge control agent, charges can be supplied to the toner from the charge control agent inside the coating layer by way of the conductive particles. It is therefore possible to stably charge the toner over a long period of time, thus leading to a developer which can more stably form high-quality images.

As the charge control agent, it is preferable to use an agent whose polarity is the same as that of polarity of the charged toner. In accordance with the polarity of the charged toner, a charge control agent for controlling positive charges or a charge control agent for controlling negative charges is selected. The charge control agent for controlling positive charges includes, for example, a basic dye, quaternary ammonium salt, quaternary phosphonium salt, aminopyrine, a pyrimidine compound, a polynuclear polyamino compound, aminosilane, a nigrosine dye, a derivative thereof, a triphenylmethane derivative, guanidine salt, and amidine salt.

The charge control agent for controlling negative charges includes oil-soluble dyes such as oil black and spiron black, a metal-containing azo compound, an azo complex dye, metal salt naphthenate, salicylic acid, metal complex and metal salt of a salicylic acid derivative, a boron compound, a fatty acid soap, long-chain alkylcarboxylic acid salt, and a resin acid soap. Chrome, zinc, and zirconium can be cited as the metal in the metal-containing azo compound, the azo complex dye, the metal salt naphthenate, the salicylic acid, the metal complex and metal salt of the salicylic acid derivative. Among the above-stated charge control agent for controlling negative charges, the boron compound is particularly preferable because it contains no heavy metal.

The charge control agent may be used each alone, or two or more of the agents may be used in combination. A usage of the charge control agent is not limited to a particular level and may be selected as appropriate from a wide range. A preferable usage of the charge control agent is 20 part by weight or less based on 100 parts by weight of the binder resin. When the usage of the charge control agent exceeds 20 parts by weight based on 100 parts by weight of the silicone resin, the mechanical strength of coating, i.e., the coating layer becomes low, and the adhesiveness of the coating layer to the core material becomes insufficient, with the result that the coating layer may be peeled off to thereby expose the core material. In the case where the coating layer is peeled off and the core material is thus exposed as just described, the toner spent may be easily caused, or the charges may be excessively supplied from the core material, which causes the charging to be destabilized. Furthermore, the exposure of the core material destabilizes the charging also from the environmental aspect. As an effect that the content of the charge control agent is set at 20 parts by weight or less based on 100 parts by weight of the silicone resin, when charges in the surface of the carrier are ran out attributable to replacement of the toner on the surface of the carrier caused by an increase in the number of sheets for image formation, the toner can be reliably supplied with charges from the charge control agent inside the coating layer by way of the conductive particles. It is therefore possible to more stably charge the toner, thus leading to a developer which can more stably form high-quality images.

A lower limit of the usage of the charge control agent is not particularly limited, and a preferable lower limit of the usage thereof is 1 part by weight based on 100 parts by weight of the silicone resin. That is, the usage of the charge control agent is more preferably 1 part by weight or more and 20 parts by weight or less based on 100 parts by weight of the silicone resin. When the usage of the charge control agent is less than 1 part by weight based on 100 parts by weight of the silicone resin, the effect obtained by addition of the charge control agent may not appear, possibly failing to impart sufficient charges to the toner. By setting the usage of the charge control agent at 1 part by weight or more based on 100 parts by weight of the silicone resin, the effect obtained by addition of the charge control agent more reliably appears and it is thus possible to impart sufficient charges to the toner.

The silicone resin composition may contain a silane coupling agent for more easier adjustment of a charge amount of the toner. Among the silane coupling agents, preferably used is a silane coupling agent which has an electron-releasing functional group, and more preferably used is an amino group-containing silane coupling agent. As the amino group-containing silane coupling agent, it is possible to use a heretofore known silane coupling agent, for example, indicated by the following general formula (1):

(Y)nSi(R)m (1)

wherein “m” pieces of “R”s are the same or different and represent an alkyl group, an alkoxy group, or a chlorine atom; and “n” pieces of “Y”s are the same or different and represent a hydrocarbon group containing an amino group, where “m” and “n” each represent an integer of 1 to 3 so as to satisfy the relation: m+n=4.

In the above general formula (1), examples of the alkyl group represented by R include linear or branched alkyl groups having a carbon number of 1 to 4, such as a methyl group, an ethyl group, a propyl group, an isopropyl group, a butyl group, an isobutyl group, and a tert-butyl group, among which the methyl group and the ethyl group are preferred. Examples of the alkoxy group include linear or branched alkoxy groups having a carbon number of 1 to 4, such as a methoxy group, an ethoxy group, a propoxy group, an isopropoxy group, a butoxy group, an isobutoxy group, and a tert-butoxy group, among which the methoxy group and the ethoxy group are preferred. Examples of the hydrocarbon group containing an amino group represented by Y include —(CH₂)a-X (wherein “X” represents an amino group, an aminocarbonylamino group, an aminoalkylamino group, a phenylamino group, or dialkylamino group, and “a” represents an integer of 1 to 4), and -Ph-X (wherein “X” is as described above, and “-Ph-” represents a phenylene group). Specific examples of the amino group-containing silane coupling agent include the following substances:

H₂N(H₂C)₃Si(OCH₃)₃;

H₂N(H₂C)₃Si(OC₂H₅)₃;

H₂N(H₂C)₃Si(CH₃)(OCH₃)₂;

H₂N(H₂C)₂HN(H₂C)₃Si(CH₃)(OCH₃)₂;

H₂NOCHN(H₂C)₃Si(OC₂H₅)₃;

H₂N(H₂C)₂HN(H₂C)₃Si(OCH₃)₃;

H₂N-Ph-Si(OCH₃)₃ (wherein -Ph- represents a p-phenylene group);

Ph-HN(H₂C)₃Si(OCH₃)₃ (wherein Ph- represents a phenylene group); and

(H₉C₄)₂N(H₂C)₃Si(OCH₃)₃.

The amino group-containing silane coupling agents may be used each alone, and two or more of the amino group-containing silane coupling agents may be used in combination. A usage of the amino group-containing silane coupling agent may be appropriately selected from such a range that sufficient charges are applied to the toner and that the mechanical strength, etc. of the resin-coating layer does not deteriorate. The usage of the amino group-containing silane coupling agent is preferably 10 parts by weight or less and more preferably 0.01 part by weight to 10 parts by weight, based on 100 parts by weight of silicone resin.

The silicone resin composition may contain other types of resin, together with the silicone resin, in such a range that favorable properties of the resin-coating layer formed of the silicone resin (especially, the cross-linked silicone resin) are not impaired. Examples of the other types of resin include epoxy resin, urethane resin, phenol resin, acrylic resin, styrene resin, polyamide, polyester, acetal resin, polycarbonate, vinyl chloride resin, vinyl acetate resin, cellulose resin, polyolefin, and copolymer resin and compounded resin of the resins just cited. Further, the silicone resin composition for coating may contain bifunctional silicone oil, in order to further enhance the moisture resistance, releasing property, and the like property of the resin-coating layer formed of the silicone resin (especially, the cross-linked silicone resin).

The silicone resin composition can be manufactured by mixing predetermined amounts of the silicone resin and conductive particles, and according to need, an appropriate amount of one or two additive(s) selected from the amino group-containing silane coupling agents, resins other than the silicone resin, the bifunctional silicone oils, and the like ingredient. One example of form of the silicone resin composition is a form of solution in which the components stated above are dissolved in an organic solvent. As the organic solvent, any organic solvent can be used without particular limitation as long as the silicone resin can be dissolved in the organic solvent. Examples of the organic solvent include: aromatic hydrocarbons such as toluene and xylene; ketones such as acetone and methyl ethyl ketone; ethers such as tetrahydrofuran and dioxane; higher alcohols; and a mixed solvent of two or more of the substances just cited. The use of the silicone resin compound for coating in the solvent form (hereinafter referred to as “coat-resin liquid”) allows the resin-coating layer to be easily formed on the surface of core material of the carrier. For example, the carrier is manufactured in a manner that the coat-resin liquid is applied to the surface of core material of the carrier to thereby form a coating layer and the coating layer is then heated to remove the organic solvent through volatilization and further cured under heat or merely cured during or after drying, thus resulting in the resin-coating layer.

As a method of applying the coat-resin liquid to the surface of core material of the carrier, it is possible to employ, for example, a dipping method for impregnating the core material of the carrier with the coat-resin liquid; a spraying method for spraying the core material of the carrier with the coat-resin liquid; a fluid bed process for spraying the coat-resin liquid to the core material of the carrier which is suspended in fluidizing air; and the like method. Among the methods just cited, preferred is the dipping method in which a coating can be easily formed. For drying the coating layer, a drying accelerator can be used. As the drying accelerator, it is possible to use heretofore known ingredients including metal soap formed of, for example, salts of lead, iron, cobalt, manganese, and zinc of naphthyl acid, octylic acid, etc.; and organic amines such as ethanolamine. The drying accelerators may be used each alone, or two or more of the drying accelerators may be used in combination. The coating layer is cured at a heating temperature selected according to the type of the silicone resin, and a preferable heating temperature is around 150° C. to 280° C. As a matter of course, no heating is required in the case where the silicone resin in use is the cold setting silicone resin. In this case, however, there may be heating up to around 150° C. to 280° C. for the purpose of enhancing the mechanical strength of the to-be-formed resin-coating layer, shortening the length of time for curing, and the like effect. Note that a concentration of total solid of the coat-resin liquid is not particularly limited, and may be thus adjusted in consideration of workability for application onto the core material of the carrier so that a film thickness of the cured resin-coating layer is generally 5 μm or less and preferably around 0.1 μm to 3 μm.

Although the carrier thus obtained preferably has high electrical resistivity and a spherical shape, the effects of the invention are not lost even when the carrier has conductivity and a non-spherical shape.

The developer of the invention can be manufactured by mixing the toner for use in the invention and the above-described carrier. A mixing ratio between the toner and the carrier is not particularly limited and in consideration of the use thereof in a high-speed image forming apparatus (which forms A4-sized images on 40 sheets or more per minute), it is preferred that a ratio of a total projected area of the toner (a sum of projected areas of all the toner particles) to a total surface area of the carrier (a sum of surface areas of all the carrier particles), that is, the total projected area of the toner/the total surface area of the carrier×100, be 30% to 70% in a state where a ratio represented by an average particle diameter of the carrier/an average particle diameter of the toner is 5 or more. This allows the charging property of the toner to be stably maintained in a sufficiently favorable state, resulting in a favorable developer which can stably form high-quality images for a long period of time even in a high-speed image forming apparatus.

For example, assuming that: the volume average particle diameter of the toner is set at 6.5 μm; the volume average particle diameter of the carrier is set at 90 μm; and the ratio of the total projected area of the toner to the total surface area of the carrier is set in a range of 30% to 70%, the developer will contain around 2.2 parts by weight to 5.3 parts by weight of the toner based on 100 parts by weight of the carrier. The high-speed development using the developer as just described leads to the largest amount of toner consumption and the largest amount of toner supply that is supplied to a developer tank of a developing device according to the toner consumption. The balance of supply and demand will be nevertheless lost. And when the amount of the carrier contained in the developer exceeds a value around 2.2 parts by weight to 5.3 parts by weight, the amount of charges tends to be smaller, thus failing to obtain the desired developing property, and moreover the amount of toner consumption is larger than the amount of toner supply, thus failing to impart sufficient charges to the toner, which causes the deterioration of image quality. Furthermore, when the amount of the carrier contained in the developer is small, the amount of charges tends to be larger and thus, the toner is less easily separated from the carrier through the electric field, thereby causing the deterioration of image quality.

Note that the projected area of the toner was determined as follows. Assuming that specific gravity of the toner was 1.0, the projected area of the toner was determined based on the volume average particle diameter obtained by the Coulter counter: Coulter Counter Multisizer II (trade name) manufactured by Beckman Coulter, Inc. The number of the toners relative to the weight of the toners to be mixed was counted, and the number of the toners was multiplied by the area of the toners (which was obtained based on the assumption that the area is circular) to thus obtain a total area of the toners. In a similar fashion, a total area of the carriers was determined from the weight of the carriers to be mixed based on the particle diameter which had been obtained by a Microtrac: Microtrac MT3000 (trade name) manufactured by Nikkiso Co., Ltd. In this case, specific gravity of the carrier was defined as 4.7. Using the values obtained as above, the mixing ratio between the toner and the carrier was determined by the total area of the toners/the total area of the carriers×100.

Further, in the developer of the invention, it is preferred that a ratio between a volume average particle diameter of the carrier and a volume average particle diameter of the toner (a volume average particle diameter of the carrier/a volume average particle diameter of the toner) be 5 or more, and a mixing ratio of the toner be 4% to 13% while the mixing ratio is a ratio of a weight of the toner to a total weight of the developer. When the ratio between the volume average particle diameter of the carrier and the volume average particle diameter of the toner (the volume average particle diameter of the carrier/the volume average particle diameter of the toner) is less than 5, the favorable charging state of the toner may not be maintained. The mixing ratio of the toner less than 4% tends to result in too large an amount of charges in the toner. The mixing ratio of the toner over 13% possibly causes the toner and the carrier not to be sufficiently mixed with each other, thus resulting in charging defects of the toner.

By setting a ratio between a volume average particle diameter of the carrier and a volume average particle diameter of the toner (a volume average particle diameter of the carrier/a volume average particle diameter of the toner) to be 5 or more, and setting a mixing ratio of the toner to be 4% to 13%, the mixing ratio which is a ratio of a weight of the toner to a total weight of the developer, the charge-imparting ability to the toner is stabilized so that the charging property of the toner is further stabilized, and in the case where the developer of the invention is used in a image forming apparatus for forming images at high speed, such as an electrophotographic image forming apparatus, it is possible to stably form high-quality images which are high in the resolution and density, while minimizing a consumption of the toner.

The ratio between a volume average particle diameter of the carrier and a volume average particle diameter of the toner (a volume average particle diameter of the carrier/a volume average particle diameter of the toner) is more preferably 5 or more and 30 or less. When the ratio between the volume average particle diameter of the carrier and the volume average particle diameter of the toner (the volume average particle diameter of the carrier/the volume average particle diameter of the toner) exceeds 30, the volume of the developer increases to a large extent, with the result that the developer tank is designed to have a large size, which is thus inefficient. From the perspective of setting the amount of charges of the toner to a favorable level, it is more preferable that the mixing ratio of the toner be in a range of from 4.0% to 13.0%, that is, 4.0% or more and 13.0% or less.

The developer of the invention is favorably used as an electrostatic charge image developer for developing electrostatic charge images which are formed as latent images on an image bearing member, and to be more specific, as an electrostatic charge image developer for developing electrostatic charge images which are formed through the electrophotographic image formation. In the case where the developer of the invention is used as the electrostatic charge image developer, the toner contained in the developer of the invention is used as a toner for developing electrostatic charge images. The application of the developer of the invention is not limited to the electrostatic charge image, and the developer may be used for development of the other latent images such as magnetic latent images.

[Developing Device, Image Forming Apparatus, and Image Forming Method]

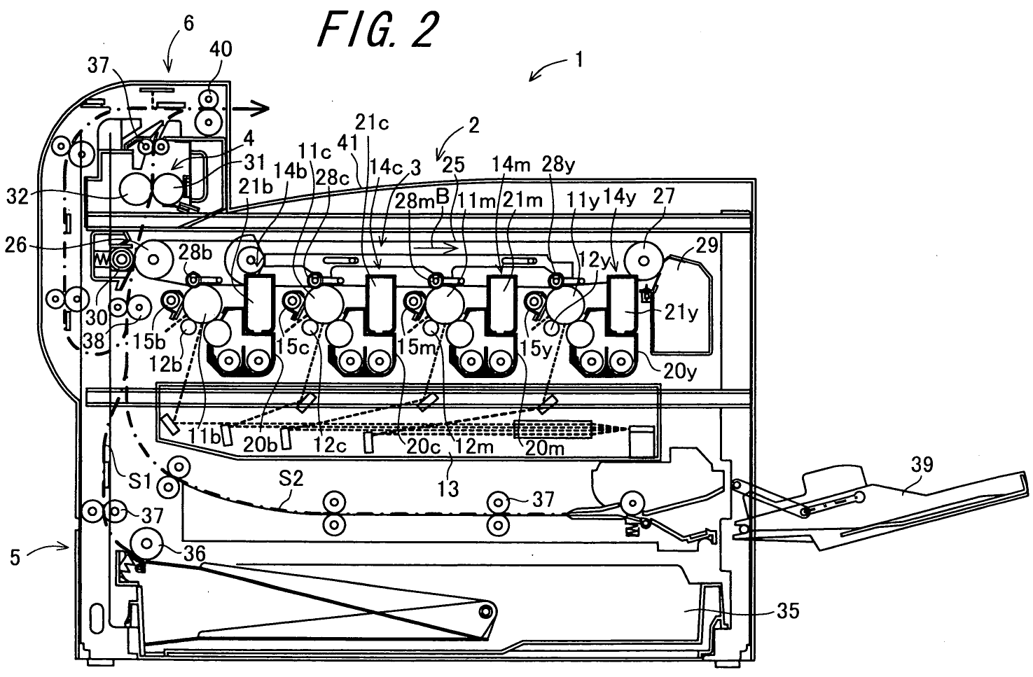

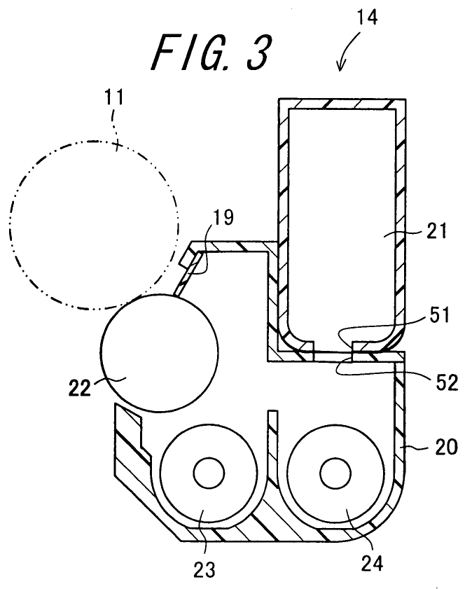

FIG. 2 is a perspective side view showing a configuration of an image forming apparatus 1 having a developing device 14 according to one embodiment of the invention. FIG. 3 is a sectional view showing a configuration of the developing device 14 according to one embodiment of the invention. The image forming apparatus 1 according to the present embodiment is an electrophotographic image forming apparatus. An image forming apparatus 1 is a multifunctional machine having a copier function, a printer function, and a facsimile function together, and according to image information being conveyed to the image forming apparatus 1, a full-color or monochrome image is formed on a recording medium. That is, the image forming apparatus 1 has three types of printer mode, i.e., a copier mode, a printer mode and a FAX mode, and the printer mode is selected by a control unit (not shown) depending on, for example, the operation input from an operation portion (not shown) and reception of the printing job from an external equipment such as a personal computer, a mobile device, an information recording storage medium, and a memory device. The image forming apparatus 1 includes a toner image forming section 2, a transfer section 3, a fixing section 4, a recording medium supply section 5, and a discharge section 6.

The image forming apparatus 1 according to the embodiment is capable of forming a multicolor image in which a plurality of different color images are combined with each other. To be more specific, the image forming apparatus 1 according to the invention is capable of forming a multicolor image which is composed of combined toner images of two or more colors selected from four colors of black (b), cyan (c), magenta (m), and yellow (y). In accordance with image information of respective colors of black (b), cyan (c), magenta (m), and yellow (y) which are contained in color image information, there are provided respectively four sets of the components constituting the toner image forming section 2 and a part of the components contained in the transfer section 3. The four sets of respective components provided for the respective colors are distinguished herein by giving alphabets indicating the respective colors to the end of the reference numerals, and in the case where the sets are collectively referred to, only the reference numerals are shown.

The toner image forming section 2 comprises a photoreceptor drum 11 serving as an image bearing member, a charging section 12, an exposure unit 13, a developing section 14, and a cleaning unit 15. The charging section 12 and the exposure unit 13 each function as a latent image forming section. The charging section 12, the developing section 14, and the cleaning unit 15 are disposed in this order around the photoreceptor drum 11. The charging section 12 is disposed vertically below the developing section 14 and the cleaning unit 15.

The photoreceptor drum 11 is rotatably supported around an axis thereof by a driving mechanism (not shown), and includes a conductive substrate and a photosensitive layer formed on a surface of the conductive substrate although not shown. The conductive substrate may be formed into various shapes such as a cylindrical shape, a circular columnar shape, and a thin film sheet shape. Among these shapes, the cylindrical shape is preferred. The conductive substrate is formed of a conductive material. As the conductive material, those customarily used in the relevant field can be used including, for example, metals such as aluminum, copper, brass, zinc, nickel, stainless steel, chromium, molybdenum, vanadium, indium, titanium, gold, and platinum; alloys formed of two or more of the metals; a conductive film obtained by forming a conductive layer containing one or two or more of aluminum, aluminum alloy, tin oxide, gold, indium oxide, etc. on a film-like substrate such as of synthetic resin film, metal film, and paper; and a resin composition containing conductive particles and/or conductive polymers. As the film-like substrate used for the conductive film, a synthetic resin film is preferred and a polyester film is particularly preferred. Further, as the method of forming the conductive layer in the conductive film, vapor deposition, coating, etc. are preferred.

The photosensitive layer is formed, for example, by stacking a charge generating layer containing a charge generating substance, and a charge transporting layer containing a charge transporting substance. In this case, an undercoat layer is preferably formed between the conductive substrate and the charge generating layer or the charge transporting layer. Provision of the undercoat layer offers advantages such as covering the flaws and irregularities present on the surface of the conductive substrate to thereby smooth the surface of the photosensitive layer, preventing degradation of the chargeability of the photosensitive layer during repetitive use, and enhancing the charging property of the photosensitive layer under a low temperature and/or low humidity circumstance. Further, the photosensitive layer may be a laminated photoreceptor having a highly-durable three-layer structure in which a photoreceptor surface-protecting layer is provided on the top layer. In the embodiment, the charge generating layer and the charge transporting layer are laminated in this order on the conductive substrate.

The charge generating layer contains as a main ingredient a charge generating substance that generates charges under irradiation of light, and optionally contains known binder resin, plasticizer, sensitizer, etc. As the charge generating substance, materials used customarily in the relevant field can be used including, for example, perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bisstilbene skeleton, distyryloxadiazole skeleton, or distyryl carbazole skeleton. Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generation ability and are suitable for obtaining a photosensitive layer at high sensitivity. The charge generating substances can be used each alone, or two or more of the charge generating substances can be used in combination. The content of the charge generating substance is not particularly limited, and preferably from 5 to 500 parts by weight and more preferably from 10 to 200 parts by weight based on 100 parts by weight of binder resin in the charge generating layer.

Also as the binder resin for charge generating layer, materials used customarily in the relevant field can be used including, for example, melamine resin, epoxy resin, silicone resin, polyurethane, acryl resin, vinyl chloride-vinyl acetate copolymer resin, polycarbonate, phenoxy resin, polyvinyl butyral, polyallylate, polyamide, and polyester. The binder resins can be used each alone or, optionally, two or more of the resins can be used in combination.

The charge generating layer can be formed by dissolving or dispersing an appropriate amount of a charge generating substance, binder resin and, optionally, a plasticizer, a sensitizer, etc. respectively in an appropriate organic solvent which is capable of dissolving or dispersing the ingredients described above, to thereby prepare a coating solution for charge generating layer, and then applying the coating solution for charge generating layer to the surface of the conductive substrate, followed by drying. The thickness of the charge generating layer obtained in this way is not particularly limited, and preferably from 0.05 to 5 μm and more preferably from 0.1 μm to 2.5 μm.

The charge transporting layer stacked over the charge generating layer contains as an essential ingredient a charge transporting substance having an ability of receiving and transporting charges generated from the charge generating substance, and binder resin for charge transporting layer, and optionally contains known antioxidant, plasticizer, sensitizer, lubricant, etc. As the charge transporting substance, materials used customarily in the relevant field can be used including, for example: electron donating materials such as poly-N-vinyl carbazole, a derivative thereof, poly-γ-carbazolyl ethyl glutamate, a derivative thereof, a pyrene-formaldehyde condensation product, a derivative thereof, polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiopnene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane, promanyl, chloranyl, and benzoquinone. The charge transporting substances can be used each alone, or two or more of the charge transporting substances can be used in combination. The content of the charge transporting substance is not particularly limited, and preferably from 10 to 300 parts by weight and more preferably from 30 to 150 parts by weight based on 100 parts by weight of the binder resin in the charge transporting substance.

As the binder resin for charge transporting layer, it is possible to use materials which are used customarily in the relevant field and capable of uniformly dispersing the charge transporting substance, including, for example, polycarbonate, polyallylate, polyvinylbutyral, polyamide, polyester, polyketone, epoxy resin, polyurethane, polyvinylketone, polystyrene, polyacrylamide, phenolic resin, phenoxy resin, polysulfone resin, and copolymer resins thereof. Among those materials, in view of the film forming property, and the wear resistance, electrical characteristics etc. of the obtained charge transporting layer, it is preferable to use, for example, polycarbonate which contains bisphenol Z as the monomer ingredient (hereinafter referred to as “bisphenol Z polycarbonate”), and a mixture of bisphenol Z polycarbonate and other polycarbonate. The binder resins can be used each alone, or two or more of the binder resins can be used in combination.

The charge transporting layer preferably contains an antioxidant together with the charge transporting substance and the binder resin for charge transporting layer. Also for the antioxidant, materials used customarily in the relevant field can be used including, for example, Vitamin E, hydroquinone, hindered amine, hindered phenol, paraphenylene diamine, arylalkane and derivatives thereof, an organic sulfur compound, and an organic phosphorus compound. The antioxidants can be used each alone, or two or more of the antioxidants can be used in combination. The content of the antioxidant is not particularly limited, and is 0.01% by weight to 10% by weight and preferably 0.05% by weight to 5% by weight based on the total amount of the ingredients constituting the charge transporting layer.

The charge transporting layer can be formed by dissolving or dispersing an appropriate amount of a charge transporting substance, binder resin and, optionally, an antioxidant, a plasticizer, a sensitizer, etc. respectively in an appropriate organic solvent which is capable of dissolving or dispersing the ingredients described above, to thereby prepare a coating solution for charge transporting layer, and applying the coating solution for charge transporting layer to the surface of a charge generating layer followed by drying. The thickness' of the charge transporting layer obtained in this way is not particularly limited, and preferably 10 μm to 50 μm and more preferably 15 μm to 40 μm. Note that it is also possible to form a photosensitive layer in which a charge generating substance and a charge transporting substance are present in one layer. In this case, the kind and content of the charge generating substance and the charge transporting substance, the kind of the binder resin, and other additives may be the same as those in the case of forming separately the charge generating layer and the charge transporting layer.

In the embodiment, as described above, there is used a photoreceptor drum which has an organic photosensitive layer using the charge generating substance and the charge transporting substance. It is, however, also possible to use, instead of the above photoreceptor drum, a photoreceptor drum which has an inorganic photosensitive layer using silicon or the like. Although the charge generating layer and the charge transporting layer are layered in this order on the conductive substrate in the embodiment, it is also possible to stack on the conductive substrate the charge transporting layer and the charge generating layer in this order.

The charging section 12 faces the photoreceptor drum 11 and is disposed away from the surface of the photoreceptor drum 11 along a longitudinal direction thereof so that a gap is formed between the charging section 12 and the photoreceptor drum 11. The charging section 12 charges the surface of the photoreceptor drum 11 so that the surface of the photoreceptor drum 11 has predetermined polarity and potential. As the charging section 12, it is possible to use a charging brush type charger, a charger type charger, a saw tooth type charger, an ion-generating device, etc. Although the charging section 12 is disposed away from the surface of the photoreceptor drum 11 in the embodiment, the configuration is not limited thereto. For example, a charging roller may be used as the charging section 12, and the charging roller may be disposed in contact-pressure with the photoreceptor drum 11. It is also possible use a contact-charging type charger such as a charging brush or a magnetic brush.

The exposure unit 13 is disposed so that light corresponding to respective color information emitted from the exposure unit 13 passes between the charging section 12 and the developing section 14 to reach the surface of the photoreceptor drum 11. In the exposure unit 13, the image information is examined to thereby form branched light corresponding to respective color information of black (b), cyan (c), magenta (m), and yellow (y) in each unit, and the surface of the photoreceptor drum 11 which has been evenly charged by the charging section 12, is exposed to the light corresponding to the respective color information to thereby form an electrostatic latent image on the surface of the photoreceptor drum 11. As the exposure unit 13, it is possible to use a laser scanning unit having a laser-emitting portion and a plurality of reflecting mirrors. The other usable examples of the exposure unit 13 may include an LED array and a unit in which a liquid-crystal shutter and a light source are appropriately combined with each other.

The developing section 14 includes, as shown in FIG. 3, a developer-regulating blade 19, a developer tank 20, a toner hopper 21, a developing roller 22, a supplying roller 23, and a stirring roller 24. The developer tank 20 is a container-shaped member, and disposed so as to face the surface of the photoreceptor drum 11. The developer tank 20 contains in an internal space thereof the developer of the invention and the developing roller 22, supplying roller 23, and stirring roller 24 which are rotatably supported by the developer tank 20. The developer tank 20 has an opening in a side face thereof opposed to the photoreceptor drum 11. The developing roller 22 is rotatably provided at a position where the developing tank 20 faces the photoreceptor drum 11 through the opening just stated.

The developing roller 22 is a developer-conveying member for carrying and thus conveying the developer. The developing roller 22 is a so-called magnet roller in which a fixed magnet body is contained. Magnetic force of the fixed magnet body causes the carrier in the developer to be magnetically stuck to the developing roller 22 whereby the developer is carried on the developing roller 22. The developing roller 22 is a roller-shaped member, and supplies a toner to the electrostatic latent image on the surface of the photoreceptor 11 at a pressure-contact portion or most-adjacent portion between the developing roller 22 and the photoreceptor drum 11. When the toner is supplied, to a surface of the developing roller 22 is applied a potential whose polarity is opposite to a polarity of the potential of the charged toner, which serves as a development bias voltage (hereinafeter referred to simply as “development bias”). By so doing, the toner on the surface of the developing roller 22 is smoothly supplied to the electrostatic latent image. Furthermore, an amount of the toner being supplied to the electrostatic latent image (a toner-attached amount) can be controlled by changing a value of the development bias. An amount of the developer carried on the surface of the developing roller 22 is regulated by the developer-regulating blade 19. The developing device 14 performs the developing operation by using the developing roller 22 to supply the toner to the electrostatic latent image formed on the surface of the photoreceptor drum 11, thereby forming a toner image which is a visualized image.

The supplying roller 23 is a roller-shaped member, and rotatably disposed opposite to the developing roller 22. The supplying roller 23 supplies the toner to the vicinity of the developing roller 22. The stirring roller 24 is a roller-shaped member, and rotatably disposed opposite to the developing roller 23. The stirring roller 24 stirs the toner which is newly supplied from the toner hopper 21 into the developer tank 22, and the toner stored inside the developer tank 22, and then feeds the toner to the vicinity of the supplying roller 23. The supplying roller 23 functions as a supply section for supplying the toner to the developing roller 22 while the stirring roller 24 is a stirring and supplying section for stirring the toner inside the developer tank 20 and supplying the toner to the supplying roller 23. Although the supply section and the stirring and supplying section are roller-shaped members, they are not limited to the roller shape and may each have a screw shape.

The toner hopper 21 is disposed so as to communicate a toner replenishment port 51 formed in a lower part of vertical direction of the toner hopper 21, with a toner reception port 52 formed in an upper part of vertical direction of the developer tank 20. The toner hopper 21 replenishes the developer tank 20 with the toner according to toner consumption. Further, it may be possible to replenish the toner directly from a toner cartridge of each color without using the toner hopper 21.

Referring back to FIG. 2, the cleaning unit 15 removes the toner which remains on the surface of the photoreceptor drum 11 after the toner image has been transferred to the recording medium, and cleans the surface of the photoreceptor drum 11. In the cleaning unit 15 is used a platy member such as a cleaning blade. In the image forming apparatus 1 according to the embodiment, an organic photoreceptor drum is used as the photoreceptor drum 11. Since a surface of the organic photoreceptor drum contains a resin component as a main ingredient, a chemical action of ozone caused by corona discharging through the charging device promotes the deterioration of the surface of the organic photoreceptor drum. The degraded surface part is, however, worn away by abrasion through the cleaning unit 15 and reliably, though gradually, removed. Accordingly, the problem of the surface degradation caused by the ozone is actually solved, and it is thus possible to stably maintain the potential of charges given by the charging operation over a long period of time. Although the cleaning unit 15 is provided in the embodiment, no limitation is imposed on the configuration, and there may be no cleaning unit 15.

In the toner image forming section 2, signal light corresponding to the image information is emitted from the exposure unit 13 to the surface of the photoreceptor drum 11 which has been evenly charged by the charging section 12, thereby forming an electrostatic latent image; the toner is then supplied from the developing section 14 to the electrostatic latent image, thereby forming a toner image; the toner image is transferred to an intermediate transfer belt 25; and the toner which remains on the surface of the photoreceptor drum 11 is removed by the cleaning unit 15. A series of a toner image forming operation just described is repeatedly carried out.

The transfer section 3 is disposed above in a vertical direction of the photoreceptor drum 11, and includes the intermediate transfer belt 25, a driving roller 26, a driven roller 27, an intermediate transferring roller 28 (b, c, m, y), a transfer belt cleaning unit 29, and a transfer roller 30.

The intermediate transfer belt 25 is an endless belt stretched out by the driving roller 26 and the driven roller 27, thereby forming a loop-shaped travel path. The intermediate transfer belt 25 rotates in an arrow B direction. When the intermediate transfer belt 25 passes by the photoreceptor drum 11 in contact therewith, the transfer bias whose polarity is opposite to the polarity of the charged toner on the surface of the photoreceptor drum 11 is applied from the intermediate transferring roller 28 which is disposed opposite to the photoreceptor drum 11 via the intermediate transfer belt 25, with the result that the toner image formed on the surface of the photoreceptor drum 11 is transferred onto the intermediate transfer belt 25. In the case of a multicolor image, the toner images of respective colors formed by the respective photoreceptor drums 11 are sequentially transferred onto the intermediate transfer belt 25 and combined thereon, thus forming a multicolor image.

The driving roller 26 can rotate around an axis thereof with the aid of a driving mechanism (not shown), and the rotation of the driving roller 26 drives the intermediate transfer belt 25 to rotate in the arrow B direction. The driven roller 27 can be driven to rotate by the rotation of the driving roller 26, and imparts constant tension to the intermediate transfer belt 25 so that the intermediate transfer belt 25 does not go slack. The intermediate transfer roller 28 is disposed in pressure-contact with the photoreceptor drum 11 via the intermediate transfer belt 25, and capable of rotating around its own axis by a driving mechanism (not shown). The intermediate transfer belt 28 is connected to a power source (not shown) for applying the transfer bias as described above, and has a function of transferring the toner image formed on the surface of the photoreceptor drum 11 to the intermediate transfer belt 25.

The transfer belt cleaning unit 29 is disposed opposite to the driven roller 27 via the intermediate transfer belt 25 so as to come into contact with an outer circumferential surface of the intermediate transfer belt 25. The toner which is attached to the intermediate transfer belt 25 by contact with the photoreceptor drum 11 may cause contamination on a reverse side of a recording medium. The transfer belt cleaning unit 29 thus removes and collects the toner on the surface of the intermediate transfer belt 25.

The transfer roller 30 is disposed in pressure-contact with the driving roller 26 via the intermediate transfer belt 25, and capable of rotating around its own axis by a driving mechanism (not shown). At a pressure-contact portion (a transfer nip portion) between the transfer roller 30 and the driving roller 26, a toner image which has been carried by the intermediate transfer belt 25 and thereby conveyed to the pressure-contact portion is transferred onto a recording medium fed from the later-described recording medium supply section 5. In the case of forming the multicolor images on the intermediate transfer belt 25, the formed multicolor images are collectively transferred onto the recording medium by the transfer roller 30. The recording medium onto which the toner image has been transferred is fed to the fixing section 4.

In the transfer section 3, the toner image is transferred from the photoreceptor drum 11 onto the intermediate transfer belt 25 at the pressure-contact portion between the photoreceptor drum 11 and the intermediate transfer roller 28, and by the intermediate transfer belt 25 rotating in the arrow B direction, the transferred toner image is conveyed to the transfer nip portion where the toner image is transferred onto the recording medium.

The fixing section 4 is provided downstream of the transfer section 3 along a conveyance direction of the recording medium, and contains a fixing roller 31 and a pressurizing roller 32. The fixing roller 31 can rotate by a driving mechanism (not shown), and heats the toner constituting an unfixed toner image carried on the recording medium so that the toner is fused to be fixed on the recording medium. Inside the fixing roller 31 is provided a heating portion (not shown). The heating portion heats the heating roller 31 so that a surface of the heating roller 31 has a predetermined temperature (heating temperature). For the heating portion, a heater, a halogen lamp, and the like device can be used. The heating portion is controlled by the later-described fixing condition control unit. In the vicinity of the surface of the fixing roller 31 is provided a temperature detecting sensor which detects a surface temperature of the fixing roller 31. A result detected by the temperature detecting sensor is written to a memory portion of the later-described control unit.

The pressurizing roller 32 is disposed in pressure-contact with the fixing roller 31, and supported so as to be rotatably driven by the rotation of the pressurizing roller 32. The pressurizing roller 32 helps the toner image to be fixed onto the recording medium by pressing the toner and the recording medium when the toner is fused to be fixed on the recording medium by the fixing roller 31. A pressure-contact portion between the fixing roller 31 and the pressurizing roller 32 is a fixing nip portion. In the fixing section 4, the recording medium onto which the toner image has been transferred in the transfer section 3 is nipped by the fixing roller 31 and the pressurizing roller 32 so that when the recording medium passes through the fixing nip portion, the toner mage is pressed and thereby fixed on the recording medium under heat, whereby an image is formed.

The recording medium supply section 5 includes an automatic paper feed tray 35, a pickup roller 36, a conveying roller 37, a registration roller 38, and a manual paper feed tray 39. The automatic paper feed tray 35 is disposed in a lower part in a vertical direction of the image forming apparatus 1 and in form of a container-shaped member for storing the recording mediums. Examples of the recording medium include, for example, plain paper, color copy paper, sheets for over head projector, and post cards. The pickup roller 36 takes out sheet by sheet the recording mediums stored in the automatic paper feed tray 35, and feeds the recording mediums to a paper conveyance path S1.

The conveying roller 37 is a pair of roller members disposed in pressure-contact with each other, and conveys the recording medium to the registration roller 38. The registration roller 38 is a pair of roller members disposed in pressure-contact with each other, and feeds to the transfer nip portion the recording medium fed from the conveying roller 37 in synchronization with the conveyance of the toner image carried on the intermediate transfer belt 25 to the transfer nip portion.

The manual paper feed tray 39 is a device for taking the recording medium into the image forming apparatus 1 by manual performance. The recording medium taken in from the manual paper feed tray 39 passes through a paper conveyance path S2 by use of the conveying roller 37, thereby being fed to the registration roller 38. In the recording medium supply section 5, the recording medium supplied sheet by sheet from the automatic paper feed tray 35 or the manual paper feed tray 39 is fed to the transfer nip portion in synchronization with the conveyance of the toner image carried on the intermediate transfer belt 25 to the transfer nip portion.

The discharge section 6 includes the conveying roller 37, a discharging roller 40, and a catch tray 41. The conveying roller 37 is disposed downstream of the fixing nip portion along the paper conveyance direction, and conveys toward the discharging roller 40 the recording medium onto which the image has been fixed by the fixing section 4. The discharging roller 40 discharges the recording medium onto which the image has been fixed, to the catch tray 41 disposed on a vertical direction-wise upper surface of the image forming apparatus 1. The catch tray 41 stores the recording medium onto which the image has been fixed.

The image forming apparatus 1 includes a control unit (not shown). The control unit is disposed, for example, in an upper part of an internal space of the image forming apparatus 1, and contains a memory portion, a computing portion, and a control portion. To the memory portion of the control unit are input, for example, various set values obtained by way of an operation panel (not shown) disposed on the upper surface of the image forming apparatus, results detected from a sensor (not shown) etc. disposed in various portions inside the image forming apparatus 1, and image information obtained from an external equipment. Further, programs for operating various means are written. Examples of the various means include a recording medium determining portion, an attached amount control unit, and a fixing condition control unit.

For the memory portion, those customarily used in the relevant filed can be used including, for example, a read only memory (ROM), a random access memory (RAM), and a hard disc drive (HDD). For the external equipment, it is possible to use electrical and electronic devices which can form or obtain the image information and which can be electrically connected to the image forming apparatus 1. Examples of the external equipment include a computer, a digital camera, a television, a video recorder, a DVD recorder, an HDVD, a blu-ray disc recorder, a facsimile machine, and a mobile device.

The computing portion takes out the various data (such as an image formation order, the detected result, and the image information) written in the memory portion and the programs for various means, and then makes various determinations. The control portion sends to a relevant device a control signal in accordance the result determined by the computing portion, thus performing control on operations. The control portion and the computing portion include a processing circuit which is achieved by a microcomputer, a microprocessor, etc. having a central processing unit. The control unit contains a main power source as well as the above-stated processing circuit. The power source supplies electricity to not only the control unit but also respective devices provided inside the image forming apparatus 1.

According to the embodiment described above, the developing device 14 develops the electrostatic latent image formed on the photoreceptor 11 by using the developer of the invention, thereby forming the toner image. There is thus achieved the developing device 14 which is capable of stably charging the toner and then performing the developing operation.

Further, in the embodiment, the developing operation is performed by the developing device 14 as described above, therefore achieving the image forming apparatus 1 which allows stable formation of high-quality images that reproduce images at high resolution with favorable color reproducibility, high image density, and a small number of image defects such as fog.

Further, in the invention, the transfer section 13 includes the intermediate transfer belt 25 which serves as an intermediate transfer belt 25. On the intermediate transfer belt 25 is formed a multicolor image by combining a plurality of different color toner images. The multicolor image is transferred onto the recording medium by the transfer roller 30.

Since the toner can be stably charged over a long period of time, the developer of the invention for use in the developing device 14 allows stable and long-lasting formation of high-resolution and high-density multicolor images which are excellent in the image reproducibility including the color reproducibility in the case of transferring the toner image twice such as the case where the transfer section 13 contains the intermediate transfer belt 25 and transfers the multicolor image onto the recording medium by way of the intermediate transfer belt 25 just like the embodiment. As just described, in the image forming apparatus where the transfer section contains the intermediate transferring member, the developing device of the invention can effectively exert the effect that high-quality images are stably formed.

The image forming apparatus 1 according to the embodiment is a multifunctional machine having a copier function, a printer function, and a facsimile function together. The application of the image forming apparatus 1 is not limited to the above embodiment, and the image forming apparatus 1 may be thus used as a copier, a printer, or a facsimile machine.

The image forming method of the invention is characterized in using the developer of the invention. The image forming method of the invention is conducted by the image forming apparatus 1 shown in FIG. 2, for example. In the image forming method of the invention, the multicolor image is formed in which a plurality of different color toner images are combined with each other, by use of the developer of the invention. This allows stable and long-lasting formation of high-resolution and high-density multicolor images which are excellent in the image reproducibility including the color reproducibility.

Further, in the case where the above-described image forming apparatus 1 shown in FIG. 2 is used in the image forming method of the invention, the multicolor image is formed by combining a plurality of the different color toner images with each other on the intermediate transfer belt 25 serving as the intermediate transferring member, and the multicolor image formed on the intermediate transfer belt 25 is transferred onto the recording medium. Since the toner can be stably charged over a long period of time, the developer of the invention allows stable and long-lasting formation of high-resolution and high-density multicolor images which are excellent in the image reproducibility including the color reproducibility in the case of transferring the toner image twice such as the case where the multicolor image is transferred onto the recording medium by way of the intermediate transfer belt 25.

The image forming method of the invention is not limited to the method using the image forming apparatus 1 shown in FIG. 2, and may be used in the other electrophotographic image forming methods, for example.

The electrophotographic image formation is carried out by using an electrophotographic image forming apparatus composed of, for example: an image bearing member having a photosensitive layer on whose surface an electrostatic image can be formed; a charging section for charging a surface of the image bearing member to a predetermined potential; an exposure section for irradiating the image bearing member whose surface has been charged, with signal light according to image information and thereby forming an electrostatic charge image (electrostatic latent image) on the surface of the image bearing member; a developing section containing a developer-conveying member, for supplying a developer to the electrostatic charge image and thereby developing the electrostatic charge image to form a toner image; a transfer section for transferring the toner image on the surface of the image bearing member onto a recording medium; a fixing section for fixing in place the toner image on a surface of the recording medium; and a cleaning section for removing a toner, paper dust, etc. which remain on the surface of the image bearing member after the toner image has been transferred onto the recording medium.

In developing the electrostatic charge image, the developer carried on the developer-conveying member is conveyed to a development region formed in a region where the developer-conveying member and the image bearing member come close, and a developing step is repeated in which an electrostatic charge image on the image bearing member is visualized through a reversal development method in an oscillating electric field formed by applying AC bias voltage to the developer-conveying member, thereafter layering on the image bearing member a plurality of toner images having different colors to thereby form a multicolor toner image.

According to the image forming method of the invention, it is possible to stably form multicolor images over a long period of time which are high in resolution and image density and excellent in image reproducibility including color reproducibility.

### EXAMPLES

Specific descriptions will be given hereinbelow concerning Reference examples, Examples, Comparative examples, and Test examples. The invention is, however, not restricted to the present examples as long as included in a gist of the invention. In the following descriptions, “part” represents “part by weight” while “%” represents “% by weight”, unless otherwise specified.

Further, an acid number, a glass transition temperature, and a number average molecular weight of the self-dispersible polyester are obtained in accordance with the following method.

[Acid Number]

The acid number was determined in the neutralizing titration method. In 20 mL of chloroform (solvent) was dissolved 0.2 g of a sample, to which were then added a few drops of an ethanol solution of phenolphthalein as an indicator. A thus-obtained solution was thereafter titrated with a 0.1 mol/L potassium hydroxide (KOH) aqueous solution. A time point when a color of the sample solution changed from achroma to purple was defined as an end. The acid number (mgKOH/g) was determined through calculation based on a required amount of the potassium hydroxide aqueous solution up to the end and a weight of the sample used for the titration.

[Glass Transition Temperature]

Using a differential scanning calorimeter: DSC210 (trade name) manufactured by Seiko Electronics Inc., a sample was heated up to 200° C. and then cooled down from 200° C. to 0° C. at a rate of 10° C./min. There was then obtained a chart which showed a peak of the sample upon a temperature rise at a rate of 10° C./min. In the chart, an extended line was drawn from a base line below the highest peak temperature, and a tangent line was also drawn at a point where a gradient thereof was maximum between a rising part and a top of the peak. A temperature at an intersection of the extended line and the tangent line was determined as the glass transition temperature.

[Number Average Molecular Weight]

A molecular weight distribution was obtained by the following gel permeation chromatography (GPC), and from an obtained molecular weight part, the number average molecular weight was determined.

Measurement device: CO-8010 (manufactured by Tosoh Corporation)

Analytical column: GMHLX+G3000HXL (manufactured by Tosoh Corporation)

Sample concentration: 0.5 g/100 ml tetrahydrofuran

Eluent: tetrahydrofuran (40° C.)

Flow rate of eluent: 1 ml/min.

Standard sample: monodisperse polystyrene

### Reference example 1

[Manufacture of Carriers (1)-(4)]

Using a three-one motor, silicone resin, conductive particles, a coupling agent, and a solvent were stirred for five minutes, each of which usage (part) was indicated in the following Table 1. There was thus prepared the silicone resin composition, i.e., the coat-resin liquid. As the solvent, toluene was used. Note that the conductive fine particles had been dispersed in the toluene solvent in advance before use with the aid of a dispersant. The coat-resin liquid was mixed with a ferrite core material whose volume average particle diameter (μm) and usage (part) were indicated in the following Table 1, and then put in a stirring machine to further mixed with each other. From an obtained admixture, toluene was removed under reduced pressure and heat so that a coating layer was formed on a surface of the ferrite core material. The coating layer was heated at 200° C. for one hour to be cured, thereby forming a resin-coating layer which was then screened out through a 100 mesh. The carries (1) to (4) were thus manufactured.

Note that specifically, the following ingredients were used as the silicone resin, conductive particles, and coupling agent indicated in Table 1. Further, the symbol “-” indicates that the component is not contained. The usage of each component shown in Table 1 is the usage of each of the following products, not a value converted using the solid content.

Silicone resin: SR2411 (trade name) which is 20%-silicone resin solution manufactured by Dow Corning Toray Co., Ltd.

Conductive fine particles A: VULCANXC 72 (trade name) which is 15%-toluene dispersion of conductive carbon black (having a primary particle diameter of 0.03 μm) manufactured by Cabot corporation

Conductive fine particles B: FS-10P (trade name) which is 30%-toluene dispersion of conductive titanium oxide (having a long axis particle diameter of 2 μm) manufactured by Ishihara Sangyo Kaisha Ltd.

Coupling agent: SH6020 (trade name) which is a 100% product manufactured by Dow Corning Toray Co., Ltd.

TABLE 1

| | Ferrite | | | | | | |
|---|---|---|---|---|---|---|---|
| | core material | | | | | | |
| | Volume | | | | | | |
| | average | | Coat-resin liquid | | | | |
| | particle | | Usage (part) | | | | |
| | diameter | Usage | Silicone | Conductive | | Coupling | Sol- |
| Carrier | μm | (part) | resin | particles | | agent | vent |
| 1 | 35 | 1000 | 175 | A | 16.6 | — | 400 |
| 2 | 55 | 1000 | 125 | B | 25 | 0.5 | 400 |
| 3 | 90 | 1000 | 75 | A | 7 | — | 350 |

| | | | | | | |
|---|---|---|---|---|---|---|
| 4 | 35 | 1000 | 175 | — | — | 400 |

### Reference Example 2

### [Manufacture of Carriers (5)-(10)]

Using a three-one motor, silicone resin, conductive particles, a charge control agent, a coupling agent, and a solvent were stirred for five minutes, each of which usage (part) was indicated in the following Table 2. There was thus prepared the silicone resin composition, i.e., the coat-resin liquid. As the solvent, toluene was used. Note that the conductive fine particles had been dispersed in the toluene solvent in advance before use with the aid of a dispersant. The coat-resin liquid was mixed with a ferrite core material whose volume average particle diameter (μm) and usage (part) were indicated in the following Table 2 and then put in a mixing machine to be further mixed with each other. From an obtained admixture, toluene was removed under reduced pressure and heat so that a coating layer was formed on a surface of the ferrite core material. The coating layer was heated at 200° C. for one hour to be cured, thereby forming a resin-coating layer which was then screened out through a 100 mesh. The carries (5) to (10) were thus manufactured.

Note that specifically, the following ingredients were used as the silicone resin, conductive particles, charge control agent, and coupling agent indicated in Table 2. Further, the symbol “-” indicates that the component is not contained. The usage of each component shown in Table 2 is the usage of each of the following products, not a value converted using the solid content.

Silicone resin: SR2411 (trade name) which is 20%-silicone resin solution manufactured by Dow Corning Toray Co., Ltd.

Conductive fine particles A: VULCANXC 72 (trade name) which is toluene dispersion of conductive carbon black with a 15% solid content (having a primary particle diameter of 0.03 μm) manufactured by Cabot corporation

Conductive fine particles B: FS-10P (trade name) which is toluene dispersion of conductive titanium oxide with a 30% solid content (having a long axis particle diameter of 2 μm) manufactured by Ishihara Sangyo Kaisha Ltd.

Charge control agent C: E-81 (trade name) which is a 5%-toluene solution of a charge control agent for negatively charging (salicylic acid metal complex), manufactured by Orient Chemical Industries, Ltd.

Charge control agent D: LR-147 (trade name) which is a 5%-acetone solution of a charge control agent for negatively charging (boro bis(1,1-diphenyl-1-oxoacetyl)potassium salt), manufactured by Japan Carlit, Co., Ltd.

Coupling agent: AY43-059 (trade name) which is a 100% product manufactured by Dow Corning Toray Co., Ltd.

TABLE 2

| | Ferrite | | Coat-resin liquid | | | | | | |
|---|---|---|---|---|---|---|---|---|---|
| | core material | | Usage (part) | | | | | | |
| | Volume | | | | | Charge | | | |
| | average | | Silicone | Conductive | | control | | Coupling | |
| | particle | | resin | particles | | agent | | agent | Solvent |
| | diameter | Usage | Usage | | Usage | | Usage | Usage | Usage |
| Carrier | (μm) | (part) | (part) | Type | (part) | Type | (part) | (part) | (part) |
| 5 | 35 | 1000 | 115 | A | 6 | C | 23 | 3 | 20 |
| 6 | 45 | 1000 | 100 | A | 6 | D | 20 | 4 | 15 |
| 7 | 90 | 1000 | 50 | A | 3 | C | 10 | 2 | 20 |
| 8 | 55 | 1000 | 75 | B | 15 | C | 15 | 3 | 20 |
| 9 | 45 | 1000 | 100 | — | — | D | 20 | 4 | 15 |
| 10 | 45 | 1000 | 100 | A | 6 | — | — | 4 | 15 |

The carriers (1) to (10) obtained in the Reference examples 1 and 2 were evaluated by a particle sizing device: Microtrac MT3000 (trade name) manufactured by Nikkiso Co., Ltd. to each obtain a volume average particle diameter. It was thus found that the obtained carriers (1) to (10) were each composed of a ferrite core material and a silicone resin layer formed on a surface of the ferrite core material.

### Reference Example 3

### [Synthesis of Self-Dispersible Polyester (A1) and Preparation of Water Dispersion (A2)]

In an autoclave provided with a thermometer and a mixing machine were put 137 parts of dimethyl terephthalate, 55 parts of dimethyl isophthalate, 68 parts of ethylene glycol, 175 parts of ethylene oxide adduct of bisphenol A (having an average molecular weight of 350), and 0.1 part of tetrabutoxy titanate (serving as a catalyst). A thus-obtained admixture was heated for 180 minutes at a temperature in a range of from 150° C. to 220° C. so that a transesterification reaction was induced. The admixture then experienced a temperature rise up to 240° C., and the pressure of reaction system was thereafter reduced little by little so as to be 10 mmHg after 30 minutes, then continuing the reaction for another 70 minutes. Subsequently, nitrogen gas replaced the gas inside the autoclave, and the internal pressure of the autoclave was set at the atmospheric pressure. The autoclave was maintained at a temperature of 200° C. and while doing so, 2 parts of trimellitic anhydride was added to the autoclave and the reaction was carried out for 70 minutes, thus manufacturing the self-dispersible polyester (A1) having an acid number of 15 mgKOH/g, a glass transition temperature of 64° C., and a number average molecular weight of 7800.

Next, in a 10-liter capacity separable flask having four openings which is provided with a thermometer, a capacitor, and a stirring blade, were put 100 parts of the self-dispersible polyester (A1), 48 parts of butanol, 12 parts of methyl ethyl ketone, and 2.0 parts of isopropanol. A thus-obtained admixture was warmed up to 70° C., thereby preparing a solution of the self-dispersible polyester (A1). To the solution was added 270 parts of 1N ammonium solution so as to have the equal acid number to that of the self-dispersible polyester resin (A1). The admixture was maintained at a temperature of 70° C. and stirred for 30 minutes, and to the admixture under stirring was added 300 parts of water, thus obtaining water dispersion of self-dispersible polyester. A thus-obtained water dispersion was put in a flask for distillation and reduced in pressure by a vacuum pump at a temperature of 70° C., whereby an organic solvent was removed from the water dispersion. Finally, a solid content was adjusted by deionized water to thereby obtain the water dispersion of self-dispersible polyester (A2) of which solid content concentration was 30%. A volume average particle diameter of resin particles of the self-dispersible polyester (A1) in the water dispersion was 0.095 μm.

### Reference Example 4

[Synthesis of Self-Dispersible Polyester (B1) and Preparation of Water Dispersion (B2)]

An operation was carried out which was the same as that of Reference example 3 except that in an autoclave provided with a thermometer and a mixing machine were put 38 parts of 1,5-naphthalene dicarboxylic acid methyl ester, 96 parts of dimethyl terephthalate, 58 parts of dimethyl isophthalate, 136 parts of ethylene glycol, and 0.1 part of tetrabutoxy titanate (serving as a catalyst) and that in the following operation, an additive amount of trimellitic anhydride was modified from 2 parts to 10 parts. As a result, there was manufactured the self-dispersible polyester (B1) having an acid number of 14 mgKOH/g, a glass transition temperature of 65° C., and a number average molecular weight of 3500.

The water dispersion of self-dispersible polyester (B2) exhibiting a solid content concentration of 30% was prepared in a manner which was the same as that of Reference example 3 except that the self-dispersible polyester (B1) obtained as above was used instead of the self-dispersible polyester (A1). A volume average particle diameter of resin particles of the self-dispersible polyester (B1) in the water dispersion was 0.080 μm.

### Reference Example 5

[Synthesis of Self-Dispersible Polyester (C1) and Preparation of Water Dispersion (C2)]

In an autoclave provided with a thermometer and a mixing machine were put 112 parts of dimethyl terephthalate, 76 parts of dimethyl isophthalate, 6 parts of 5-sodium sulfodimethyl isophthalate, 96 parts of ethylene glycol, 50 parts of propylene glycol, and 0.1 part of tetrabutoxy titanate (serving as a catalyst). A thus-obtained admixture was heated for 120 minutes at a temperature in a range of from 180° C. to 230° C. so that a transesterification reaction was induced. The reaction system then experienced a temperature rise up to 250° C. while the pressure of the reaction system was set to fall in a range of from 1 mmHg to 10 mmHg, and the reaction was carried out for 60 minutes, thus manufacturing the self-dispersible polyester (C1) having an acid number of 0.1 mgKOH/g, a glass transition temperature of 58° C., and a number average molecular weight of 3100.

The water dispersion of self-dispersible polyester (C2) exhibiting a solid content concentration of 30% was prepared in a manner which was the same as that of Reference example 3 except that the self-dispersible polyester (C1) obtained as above was used instead of the self-dispersible polyester (A1). A volume average particle diameter of resin particles of the self-dispersible polyester (C1) in the water dispersion was 0.2 μm.

Table 3 collectively shows characteristics of the water dispersions of self-dispersible polyester obtained in Reference examples 3-5.

TABLE 3

| | | Water dispersion of | | |
|---|---|---|---|---|
| | | self-dispersible | | |
| | | polyester | | |
| Component/Property | | A2 | B2 | C2 |
| Self-dispersible | Type | A1 | B1 | C1 |
| polyester | Acid number | 15 | 14 | 0.1 |
| | (mgKOH/g) | | | |
| | Glass transition | 64 | 65 | 58 |
| | temperature (° C.) | | | |
| | Number average | 7800 | 3500 | 3100 |
| | molecular weight | | | |

| | | | |
|---|---|---|---|
| Solid content concentration (%) | 30 | 30 | 30 |
| Volume average particle diameter of | 0.095 | 0.080 | 0.2 |
| resin particles (μm) | | | |

### Reference Example 6

[Preparation of Blue Pigment Water Dispersion (I)]

Using a planetary ball mill manufactured by Fritsch Co., Ltd., 50 parts of cyan pigment: Eupolen Blue 69-1501 (trade name) manufactured by BASF Co., Ltd., 5 parts of an anionic surfactant: Neogen R (trade name) manufactured by Dai-ichi Kogyo Seiyaku Co., Ltd., and 223 parts of ion-exchange water were dispersed for 40 minutes with the aid of 0.5 mm-sized zirconia beads. Subsequently, a thus-obtained admixture was put in a mixing machine: Polytron Homogenizer PT3000 (trade name) manufactured by Kinematica Co. and stirred for 20 minutes at room temperature, and further dispersed for 20 minutes by an ultrasonic homogenizer manufactured by Nippon Seiki Co., Ltd., thus preparing blue pigment water dispersion (I) that blue pigment having a volume average particle diameter of 0.10 μm was dispersed in water. Note that the average particle diameters of the pigment and later-described wax particles were measured by a laser diffraction/scattering particle size distribution analyzer: Microtrac UPA-EX150.

### Reference Example 7

[Preparation of Red Pigment Water Dispersion (II)]

An operation was carried out which was the same as that of Reference example 6 except that magenta pigment: Eupolen Red 47-9001 (trade name) manufactured by BASF Co., Ltd. was used instead of the cyan pigment, thus preparing red pigment water dispersion (II) that red pigment having a volume average particle diameter of 0.09 μm was dispersed in water.

### Reference Example 8

[Preparation of Yellow Pigment Water Dispersion (III)]

An operation was carried out which was the same as that of Reference example 6 except that yellow pigment: Eupolen Yellow 09-6101 (trade name) manufactured by BASF Co., Ltd. was used instead of the cyan pigment, thus preparing yellow pigment water dispersion (III) that yellow pigment having a volume average particle diameter of 0.08 μm was dispersed in water.

### Reference Example 9

[Preparation of Black Pigment Water Dispersion (IV)]

Using a planetary ball mill manufactured by Fritsch Co., Ltd., 50 parts of carbon black: Mogul L (trade name) manufactured by Cabot corporation, 5 parts of a nonionic surfactant: Nonipol 400 (trade name) manufactured by Sanyo Chemical Industries, Ltd., and 223 parts of ion-exchange water were dispersed for 40 minutes with the aid of 0.5 mm-sized zirconia beads. Subsequently, a thus-obtained admixture was put in the homogenizer (PT3000) and stirred for 20 minutes at room temperature, thus preparing black pigment water dispersion (IV) that carbon black having a volume average particle diameter of 0.13 μm was dispersed in water.

### Reference Example 10

[Preparation of Wax-Water Dispersion]

In a jacketed stainless steal beaker were put 50 parts of paraffin wax: HNP10 (trade name) which has a melting point of 72° C. and is manufactured by Nippon Seiro Co., Ltd., 5 parts of the anionic surfactant (Neogen R), and 161 parts of ion-exchange water. A thus-obtained admixture was dispersed under heat of 95° C. by the homogenizer (PT3000) for 30 minutes. The admixture was subsequently moved to a pressure discharging type homogenizer manufactured by Nippon Seiro Co., Ltd. to be thereby treated with a dispersion process under heat of 90° C. for 20 minutes, thus preparing wax-water dispersion in which wax fine particles having a volume average particle diameter of 0.4 μm were dispersed in water and of which solid content concentration was 25%.

### Examples 1-4

[Admixture Preparing Step]

The water dispersion of self-dispersible polyester, the pigment water dispersion, and the wax-water dispersion were mixed with each other. Table 4 listed below shows usages of these ingredients where the unit is “part” as converted using the solid content. To a thus-obtained admixture was added pure water as necessary. There was thus prepared a toner raw material admixture of which solid content concentration was 10%. Note that at the present step, the usage of the water dispersion of self-dispersible polyester was 85% of that indicated in Table 4.

[Aggregate Forming Step]

A toner admixture obtained as above was put in a Maxblend agitator manufactured by NGK Insulators, Ltd., and 270 parts of 1%-aqueous solution of magnesium chloride (an aggregating agent) was dripped little by little to the toner admixture which was being stirred (at the rate of 1500 rpm). After completion of dripping, the admixture was stirred for one hour to thereby form an aggregate (aggregated particles). Next, the water dispersion of self-dispersible polyester (the other 15% of the usage indicated in Table 4) was mixed with the admixture. To a thus-obtained admixture was further dripped little by little 30 parts of 1%-aqueous solution of magnesium chloride, and after completion of dripping, the admixture was stirred for one hour to thereby form an aggregate (aggregated particles).

[Particle Forming Step]

An aqueous medium containing the aggregate obtained as above was heated up to 75° C. and then stirred for 30 minutes, and further stirred for 20 minutes at a temperature of 94° C., thereby forming toner particles which are uniform in particle diameter and shape.

[Cleaning Step]

An aqueous medium containing the toner particles obtained as above was filtered to thereby separate the toner particles from the aqueous medium. The toner particles were mixed with pure water of which mixing ratio was 4 parts based on 1 part of the toner particles, and a cleaning operation of separating the toner particles through filtration was repeated five times. Next, the toner particles were mixed with a hydrochloride aqueous solution (pH 2) of which mixing ratio was 4 parts based on 1 part of the toner particles, and the same cleaning operation as stated above was repeated three times. The toner particles were then dried by a vacuum drier, thus preparing toners of Examples 1-4.

The pure water for use in the cleaning was pure water having a conductivity of 0.5 μS/cm which was prepared from tap water by using a ultra pure water production apparatus: Ultra Pure Water System CPW-102 (trade name) manufactured by ADVANTEC Co. For measurement of pH and conductivity of the water, there was used a Lacom Tester: EC-PHCON 10 (trade name) manufactured by Iuchi Seiei Do Co., Ltd.

With 100 parts of the toner particles obtained as above were mixed 0.7 part of silica particles having an average primary particle diameter of 20 nm which had been surface-treated with a silane coupling agent. There were thus prepared toners of Examples 1-4.

### Example 5

Toner particles were manufactured in a manner which was the same as that of Example 4 except that a total amount of the water dispersion of self-dispersible polyester was used at the admixture preparing step and that at the aggregate forming step, there were no addition of water dispersion of self-dispersible polyester and no secondary addition of aqueous solution of magnesium chloride. There was thus prepared a toner of Example 5.

### Comparative Example 1

Toner particles were manufactured in a manner which was the same as that of Example 1 except that the usages of the water dispersion of self-dispersible polyester (C2) and the pigment water dispersion (IV) were the usages thereof indicated in Table 4 (unit: part, all converted using the solid content). There was thus prepared a toner of Comparative example 1.

### Comparative Example 2

Toner particles were manufactured in a manner which was the same as that of Example 4 except that the aggregating agent was changed to a 1.5%-aqueous solution of alkylbenzyl ammonium chloride: Sanizol B50 (trade name) manufactured by Kao Corporation. There was thus prepared a toner of Comparative example 2.

[Evaluation 1]

The toners obtained in Examples 1-5 and Comparative examples 1 and 2 were evaluated for volume average particle diameter, variation coefficient, and average degree of circularity.

Furthermore, 5 parts of the toner of Examples 1-5 and Comparative example 1 were each mixed with 100 parts of the carrier (1), thereby preparing the developer of the invention. The developer was evaluated for image density, fog, environmental stability, and a transfer rate. To be specific, each of the evaluations was conducted as follows. The result was shown in Table 4 in which “Good” indicates that a very excellent result was obtained regarding the evaluation item marked therewith. The symbol “-” in Table 4 indicates that no evaluation was carried out. As to the toner of Comparative example 2, the variation coefficient was evaluated as “Poor” and therefore, the evaluations “Poor” were given to the image density, fog, environmental stability, and transfer rate without the evaluation tests.

[Volume Average Particle Diameter and Variation Coefficient]

The volume average particle diameter (μm) and the variation coefficient (CV value) of the toner particles were determined through the measurement by use of a particle sizing device: Coulter Counter Multisizer II (trade name) manufactured by Beckman Coulter, Inc. under conditions that the number of particles for measurement was set at 50,000 counts and an aperture diameter was set at 100 μm.

To be specific, the volume average particle diameter and the variation coefficient (CV value) are determined as follows. To 50 ml of electrolyte: ISOTON-II (trade name) manufactured by Beckman Coulter, Inc. were added 20 mg of sample and 1 ml of sodium alkylether sulfate ester. A thus-obtained admixture was treated by a dispersion process of an ultrasonic distributor: UH-50 (trade name) manufactured by SMT Co., Ltd., for three minutes at an ultrasonic frequency of 20 kz, thereby preparing a sample for measurement. The sample for measurement was then evaluated by a Coulter counter: Coulter Counter Multisizer II (trade name) manufactured by Beckman Coulter, Inc. under conditions that an aperture diameter was set at 100 μm and the number of particles for measurement was set at 50,000 counts, thereby determining from a volume particle size distribution of sample particles the volume average particle diameter and standard deviation in the volume particle size distribution. The variation coefficient (the CV value, %) was determined based on the following formula. The evaluation “Good” was given to a case where the variation coefficient was 40 or less, and the evaluation “Poor” was given to a case where the variation coefficient exceeded 40.

CV value (%)=(Standard deviation in volume particle size distribution/Volume average particle diameter)×100

[Average Degree of Circularity]

Using a flow-type particle image analyzer: FPIA-2000 (trade name) manufactured by To a Medical Electronics Co., Ltd., a boundary length of projected image of toner particle was measured. The average degree of circularity of toner particles was then determined based on the following formula. In general, the average degree of circularity is a value of 1 or less.

Average degree of circularity=(Boundary length of perfect circle having the same area as that of projected image/Boundary length of projected image)

[Image Density]

The image density was evaluated by measuring optical density of an evaluation image through a spectrodensitometer: X-Rite 938 (trade name) manufactured by Nippon Lithograph Inc. The evaluation “Good” was given to a case where the optical density was 1.2 or more, and the evaluation “Poor” was given to a case where the optical density was less than 1.2. The evaluation image was fabricated in a manner that the developer of the invention was used in a digital full color multifunction printer: AR-C150 (trade name) manufactured by Sharp Corporation, of which developing device was remodeled so as to be adapted for the above-described developer of the invention, thereby transferring a color toner image onto a sheet for full-color images: PP106A4C (trade name) manufactured by Sharp Corporation while adjusting an attached amount of toner to be 0.6 mg/cm², and then fixing the color toner image onto the sheet by an external fixing machine.

[Fog]

The fog was evaluated by determining fog density W (%) based on the following formula. The evaluation “Good” was given to a case where the fog density W was 2.0% or less, and the evaluation “Poor” was given to a case where the fog density W exceeded 2.0%.

W (%)=[(W1−W2)/W1]×100

In the above formula, W1 represents whiteness of the A4-sized sheet for full color images: PP106A4C (trade name) manufactured by Sharp Corporation, and W2 represents whiteness of white part in a duplicated image which is obtained by copying three sheets of a document containing a 55 mm-diameter while circle. Both of the whiteness were measured by use of a whiteness checker: Z-Σ90 Color Measuring System (trade name) manufactured by Nippon Denshoku Industries Co., Ltd.

[Environmental Stability]

A predetermined amount of the developer of the invention was put in a developing tank and preserved one day and night, respectively, under the low-temperature and low-humidity circumstance (a) that the temperature was 5° C. and the humidity was 10% and under the high-temperature and high-humidity circumstance (b) that the temperature was 35° C. and the humidity was 80%. The developer was then rotated for 2 minutes at a rotating speed equal to that of the above image forming apparatus (AR-C150). At this time, a charge amount of the toner was measured. The evaluation was then conducted by determining a relative ratio (rate of change) of the charge amount of the toner under the high-temperature and high-humidity condition, i.e., (b) indicated above to the charge amount of the toner under low-temperature and low-humidity condition, i.e., (a) indicated above. The evaluation “Good” was given to a case where the relative ratio (rate of change) exceeded 75%, and the evaluation “Poor” was given to a case where the relative ratio (rate of change) was 75% or less.

[Transfer Rate]

The transfer rate T (%) was determined based on the following formula. The evaluation “Good” was given to a case where the transfer rate T was 90% or more, and the evaluation “Poor” was given to a case where the transfer rate T was less than 90%.

T (%)=[Mp/(Md+Mp)]×100

In the above formula, Mp represents a weight of toner on a sheet where a predetermined chart was duplicated, and Md represents a weight of toner which remained on a surface of the image bearing member (electrophotographic photoreceptor) in duplicating the predetermined chart. The predetermined chart mentioned herein is a chart that 4 cm×4 cm patches are formed in four corners of the A4-sized sheet (1.5 cm inside from each end of the sheet) and on a central part of the sheet.

[Comprehensive Evaluation]

On the basis of the evaluation results obtained as above, the comprehensive evaluation was carried out. In the comprehensive evaluation, the evaluation “Good” was given to a case where none of the variation coefficient, the image density, the fog, the environmental stability, and the transfer rate were evaluated as “Poor”, and the evaluation “Poor” was given to a case where one or more of the variation coefficient, the image density, the fog, the environmental stability, and the transfer rate were evaluated as “Poor”.

TABLE 4

| | | | Example | | | | | Com. Ex. | |
|---|---|---|---|---|---|---|---|---|---|
| | | | 1 | 2 | 3 | 4 | 5 | 1 | 2 |
| Toner raw material | Water | A2 | 90 | | 90 | | | | |
| | dispersion of | B2 | | 90 | | 87 | 87 | | 87 |
| | self- | C2 | | | | | | 87 | |
| | dispersible | | | | | | | | |
| | polyester | | | | | | | | |
| | Pigment-water | I | | 5 | | | | | |
| | dispersion | II | 5 | | | | | | |
| | | III | | | 5 | | | | |
| | | IV | | | | 8 | 8 | 8 | 8 |
| | Wax-water dispersion | | 5 | 5 | 5 | 5 | 5 | 5 | 5 |
| Evaluation test | Volume average particle | | 6.5 | 7.3 | 6.9 | 7.1 | 7.3 | 7.1 | 25 |
| | diameter μm | | | | | | | | |
| | Variation | Data | 28 | 29 | 26 | 29 | 28 | 29 | 50 |
| | coefficient | Evaluation | Good | Good | Good | Good | Good | Good | Poor |
| | Average degree of | | 0.97 | 0.97 | 0.97 | 0.97 | 0.97 | 0.97 | 0.88 |
| | circularity | | | | | | | | |
| | Image density | Data | 1.4 | 1.3 | 1.3 | 2.0 | 1.9 | 1.9 | — |
| | | Evaluation | Good | Good | Good | Good | Good | Good | Poor |
| | Fog | Data | 0.8 | 0.9 | 0.7 | 0.7 | 0.8 | 1.2 | — |
| | | Evaluation | Good | Good | Good | Good | Good | Good | Poor |
| | Environmental | Data | 88 | 88 | 95 | 89 | 77 | 57 | — |
| | stability | Evaluation | Good | Good | Good | Good | Good | Poor | Poor |
| | Transfer rate % | Data | 95 | 96 | 96 | 95 | 96 | 91 | — |
| | | Evaluation | Good | Good | Good | Good | Good | Good | Poor |

| | | | | | | | |
|---|---|---|---|---|---|---|---|
| Comprehensive evaluation | Good | Good | Good | Good | Good | Poor | Poor |

Table 4 shows that in Examples 1-5, toners can be manufactured of which various toner properties are in high level such as a narrow width of particle size distribution (a small variation coefficient), high image density and high transfer rate, less frequent generation of fog, and favorable environmental stability. The comparison between Example 4 and Example 5 reveals that the environmental stability of charging property of toner is further enhanced by repeating the aggregate forming operation at the aggregate forming step. Further, the comparison between Example 4 and Comparative example 1 reveals that the toner using self-dispersible polyester (A1) whose acid number falls within a range of 1 mgKOH/g to 30 mgKOH/g is far more excellent in environmental stability than the toner using self-dispersible polyester (C1) whose acid number is out of the range of 1 mgKOH/g to 30 mgKOH/g. Furthermore, the comparison between Example 4 and Comparative example 2 reveals that the use of the polyvalent metal salt as the aggregating agent allows stable fabrication of toner particles of which volume average particle diameter is small and of which fluctuation band of the volume average particle diameter is narrow.

### Examples 6-8 and Comparative Examples 3-5

The toner obtained in Example 1 was mixed with 100 parts of the carriers obtained in Reference example 1 at mixing ratios shown in Table 5, thereby preparing developers of the invention (using the carriers 1-3) and a developer of Comparative example (using the carriers 1 and 4).

[Evaluation 2]

The developers obtained in Examples 6-8 and Comparative examples 3-5 were evaluated for a charge amount of the toner, image density of an image formed by use of the developer, and environmental stability of the developer. To be specific, each of the evaluations was conducted as follows. The result was shown in Table 5 in which “Good” indicates that a very excellent result was obtained regarding the evaluation item marked therewith.

[Charge Amount of Toner]

The developers of the invention and developer of Comparative example obtained as above were respectively weighed to 20 g and put in a 100 cc plastic bottle. The developers were then stirred on two-rolls and after one hour, the charge amounts (μC/g) were measured by a charge amount measuring machine (Trek). The evaluation “Good” was given to a case where a measurement value of charge amount of toner was in a range of from 20 μC/g to 50 μC/g, and the evaluation “Poor” was given to the other cases.

[Image Density]

Images formed by use of 500 g of the developers of the invention and developer of Comparative examples were evaluated for image density in a manner which is the same as that of Evaluation 1. The evaluation standards were also the same as described above.

[Environmental Stability]

A predetermined amount of the developer of the invention was put in a developing tank and preserved one day and night, respectively, under the low-temperature and low-humidity circumstance (a) that the temperature was 5° C. and the humidity was 10% and under the high-temperature and high-humidity circumstance (b) that the temperature was 35° C. and the humidity was 80%. The developer was then rotated for 2 minutes at a rotating speed equal to that of the above image forming apparatus (AR-C150). At this time, the charge amount of the toner was measured. The evaluation was then conducted by determining a relative ratio (rate of change) of the charge amount of the toner under the high-temperature and high-humidity condition, i.e., (b) indicated above to the charge amount of the toner under low-temperature and low-humidity condition, i.e., (a) indicated above. The evaluation “Good” was given to a case where the relative ratio (rate of change) exceeded 75%, and the evaluation “Poor” was given to a case where the relative ratio (rate of change) was 75% or less.

TABLE 5

| | | | | | Comparative | | |
|---|---|---|---|---|---|---|---|
| | | Example | | | example | | |
| | | 6 | 7 | 8 | 3 | 4 | 5 |
| Carrier | | 1 | 2 | 3 | 4 | 1 | 1 |
| Volume average particle | | 35 | 55 | 90 | 35 | 35 | 35 |
| diameter of carrier (μm) | | | | | | | |
| Mixed amount of toner | | 4.7 | 5.0 | 4.3 | 4.7 | 4.0 | 15.5 |
| (part) | | | | | | | |
| Mixing ratio of toner | | 4.5 | 4.8 | 4.1 | 4.5 | 3.8 | 13.4 |
| (%) | | | | | | | |
| Ratio of volume average | | 5.4 | 8.5 | 13.8 | 5.4 | 5.4 | 5.4 |
| particle diameter | | | | | | | |
| Charge amount | Data | 30 | 41 | 25 | 19 | 40 | 16 |
| (μC/g) | Evaluation | Good | Good | Good | Poor | Good | Poor |
| Image density | Data | 1.4 | 1.5 | 1.3 | 1.4 | 1.3 | 1.6 |
| | Evaluation | Good | Good | Good | Good | Good | Good |
| Environmental | Data | 88 | 85 | 90 | 70 | 74 | 78 |
| stability | Evaluation | Good | Good | Good | Poor | Poor | Good |

### Examples 9-13 and Comparative Examples 6-8

The toner obtained in Example 1 was mixed with 100 parts of the carriers obtained in Reference example 2 at mixing ratios shown in Table 6, thereby preparing developers of the invention, i.e., developers of Examples 9-13 (using the carriers 5-8 and 10), and developers of Comparative examples 6-8 (using the carriers 5, 8 and 9).

[Evaluation 3]

The developers obtained in Examples 9-13 and Comparative examples 6-8 were evaluated for a charge amount of the toner, and life stability of the developer. The charge amount of the toner were evaluated in the same manner as Evaluation 2. The evaluation standards were also set to be the same as Evaluation 2. To be specific, the life stability of the developer was evaluated as follows. The result was shown in Table 6 in which “Good” indicates that a very excellent result was obtained regarding the evaluation item marked therewith.

[Life Stability]

The developer was set in a developer tank of a developing device in a remodeled machine of commercially-available copier having a two-component developing device: MX-6200N (trade name) manufactured by Sharp Corporation, and at ordinary temperature and humidity that the temperature was 25° C. and the relative humidity was 50%, a solid image was copied as an image for evaluation at an initial stage, and 50,000 sheets of solid images were furthermore copied, thereafter forming a solid image as an image for evaluation after repetitive use. In each image for evaluation at the initial stage and after repetitive use, image density of a solid image part to which toner had been attached was measured.

The image density was determined by measuring density of reflectance density of the solid image part through a spectrodensitometer: X-Rite 938 (trade name) manufactured by Nippon Lithograph Inc. The evaluation “Good” was given to a case where the image density was 1.4 or more, and the evaluation “Poor” was given to a case where the image density was less than 1.4.

Further, the developer in the developer tank was taken out before the copying operation of solid images of 50,000 sheets and after the formation of images for evaluation after repetitive use to measure the charge amount (μC/g) of the toner in the developer. The charge amount of the toner was measured by a suction charge amount measuring device: 210H-2A (trade name) manufactured by TREK Co., Ltd. A charge amount before the copying operation of solid images of 50,000 sheets was defined as a charge amount at an initial stage while a charge amount after the formation of images for evaluation after repetitive use was defined as a charge amount after repetitive use. An absolute value of a difference between the charge amount at the initial stage and the charge amount after repetitive use was determined as charge variation. The evaluation “Good” was given to a case where the charge variation was 10 μC/g or less; the evaluation “available” was given to a case where the charge variation was more than 10 μC/g and 15 μC/g or less; and the evaluation “Poor” was given to a case where the charge variation was more than 15 μC/g.

TABLE 6

| | | | | | | | | | Comparative | | |
|---|---|---|---|---|---|---|---|---|---|---|---|
| | | | | Example | | | | | Example | | |
| | | | | 9 | 10 | 11 | 12 | 13 | 6 | 7 | 8 |
| Carrier | | | | 5 | 6 | 7 | 8 | 10 | 9 | 5 | 8 |
| Volume average particle | | | | 35 | 45 | 90 | 55 | 45 | 45 | 35 | 55 |
| diameter of carrier (μm) | | | | | | | | | | | |
| Mixed amount of toner (part) | | | | 6.7 | 4.5 | 15.0 | 10.8 | 8.0 | 7.6 | 3.1 | 16.5 |
| Mixing ratio of toner (%) | | | | 6.3 | 4.3 | 13.0 | 9.7 | 7.4 | 7.1 | 3.0 | 14.2 |
| Ratio of volume average | | | | 5.4 | 6.9 | 13.8 | 8.5 | 6.9 | 6.9 | 5.4 | 8.5 |
| particle diameter | | | | | | | | | | | |
| Charge amount | | | Data | 30 | 41 | 25 | 27 | 32 | 15 | 45 | 18 |
| (μC/g) | | | Evaluation | Good | Good | Good | Good | Good | Poor | Good | Poor |
| Life stability | Image | Initial | Data | 1.5 | 1.6 | 1.6 | 1.7 | 1.6 | 1.5 | 1.3 | 1.6 |
| | density | stage | Evaluation | Good | Good | Good | Good | Good | Good | Poor | Good |
| | | After | Data | 1.4 | 1.5 | 1.6 | 1.6 | 1.5 | 1.4 | 1.3 | 1.1 |
| | | repetitive | Evaluation | Good | Good | Good | Good | Good | Good | Poor | Poor |
| | | use | | | | | | | | | |

| | | | | | | | | | |
|---|---|---|---|---|---|---|---|---|---|
| Charge | Data | 8 | 9 | 5 | 6 | 14 | 8 | 20 | 4 |
| variation | Evaluation | Good | Good | Good | Good | Available | Good | Poor | Good |
| (μC/g) | | | | | | | | | |

The above results show that the charge amount is stable when the ratio of volume average particle diameter (the volume average particle diameter of the carrier/the volume average particle diameter of the toner) is 5 or more and the mixing ratio of the toner is 4% to 13%.

Further, it is also found that the charge amount decreases upon using the carrier (4) or (9) of which resin-coating layer contains no conductive particles, as in Comparative example 3 and Comparative example 6. Still further, it is found that no environmental stability can be obtained when the mixing ratio of the toner is less than 4% as in Comparative example 4. Furthermore, it is found that no life stability can be obtained when the mixing ratio of the toner is less than 4% as in Comparative example 7. Moreover, it is found that the reduction of charge amount can be observed when the mixing ratio of the toner exceeds 13% as in Comparative examples 5 and 8. In addition, from the evaluation result of life stability in Comparative Example, it is found that, as in Comparative Example 8, when the mixing ratio of the toner exceeds 13%, high image density is obtained at an initial stage, while image density decreases after repetitive use and a desired image density cannot be obtained. With respect to the developer of Comparative example, when visually observing a condition after the evaluation of life stability, the developer exhibits the aggregating tendency and leads to defective chain formation of the magnetic brush. It is considered that this defective chain formation results in a decrease in the image density.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A developer comprising:
a toner containing pigment and self-dispersible resin which contains self-dispersible polyester having an acid number of 1 mgKOH/g to 30 mgKOH/g; and
a carrier composed of a core material and a coating layer which is formed on a surface of the core material and contains conductive particles.

2. The developer of claim 1, wherein the self-dispersible polyester is formed by polycondensation of an alcohol compound containing polyhydric alcohol and a carboxylic compound containing one or two or more selected from polycarboxylic acids having three or more carboxylic groups in one molecule and acid anhydrides of the polycarboxylic acids.

3. The developer of claim 1, wherein the coating layer is formed of a silicone resin composition containing the conductive particles and silicone resin.

4. The developer of claim 3, wherein the silicone resin composition contains 30 parts by weight or less of the conductive particles based on 100 parts by weight of the silicone resin.

5. The developer of claim 1, wherein the coating layer further contains a charge control agent.

6. The developer of claim 5, wherein the coating layer is formed of a silicone resin composition containing the conductive particles, the charge control agent, and silicone resin, and
the silicone resin composition contains 20 parts by weight or less of the charge control agent based on 100 parts by weight of the silicone resin.

7. The developer of claim 1, wherein a volume average particle diameter of the core material falls in a range of from 25 μm to 150 μm.

8. The developer of claim 1, wherein the core material is made of ferrite particles.

9. The developer of claim 1, wherein a ratio between a volume average particle diameter of the carrier and a volume average particle diameter of the toner (a volume average particle diameter of the carrier/a volume average particle diameter of the toner) is 5 or more, and a mixing ratio of the toner is 4% to 13%, the mixing ratio which is a ratio of a weight of the toner to a total weight of the developer.

10. A developing device which develops a latent image formed on an image bearing member using the developer of claim 1 and thereby forms a toner image.

11. An image forming apparatus comprising:
an image bearing member on which a latent image is formed;
a latent image forming section for forming the latent image on the image bearing member; and
the developing device of claim 10.

12. The image forming apparatus of claim 11, further comprising:
an intermediate transferring member on which a plurality of different color toner images formed by developing operations of the developing device are combined with each other to form a multicolor image; and
a transfer section for transferring the multicolor image formed on the intermediate transferring member onto a recording medium.

13. An image forming method in which the developer of claim 1 is used to form a multicolor image composed of a plurality of different color toner images combined with each other.

14. The image forming method of claim 13, wherein the plurality of the different color toner images are combined to form the multicolor image on an intermediate transferring member, and the formed multicolor image is transferred onto a recording medium.
